(19) United States
(12) Patent Application Publication
(10) Pub. No.: US 2020/0203995 A1
(43) Pub. Date: Jun. 25, 2020

(54) POWER-FEEDING DEVICE AND WIRELESS POWER-FEEDING SYSTEM

(71) Applicant: SEMICONDUCTOR ENERGY LABORATORY CO., LTD., ATSUGI-SHI, KANAGAWA-KEN (JP)

(72) Inventor: Takeshi OSADA, Isehara, Kanagawa (JP)

(73) Assignee: SEMICONDUCTOR ENERGY LABORATORY CO., LTD., ATSUGI-SHI, KANAGAWA-KEN (JP)

(21) Appl. No.: 16/629,052

(22) PCT Filed: Jul. 4, 2018
(86) PCT No.: PCT/IB2018/054931

§ 371 Date: Jan. 7, 2020

(30) Foreign Application Priority Data
Jul. 14, 2017 (JP) 2017-138238

(51) Int. Cl. H02J 50/12; H02J 50/90; H04B 5/00

(52) U.S. Cl. CPC H02J 50/12; H04B 5/0081; H02J 50/90

(57) ABSTRACT

The transmission efficiency of a wireless power-feeding system is increased. A power-feeding device to be provided includes a power-feeding coil, a control device, a sensing device, and a moving device, in which the power-feeding coil has a function of generating a magnetic field, the control device is electrically connected to the power-feeding coil and the sensing device and has a function of determining a position of the power-feeding coil and a function of transmitting a position control signal, the moving device has a function of receiving the position control signal and a function of moving the power-feeding coil on the basis of the position control signal, the sensing device includes a first sensing coil and a second sensing coil, the first sensing coil has a function of generating a magnetic field, and the second sensing coil has a function of sensing a change in magnetic flux density.

### TECHNICAL FIELD

One embodiment of the present invention relates to a power-feeding device and a wireless power-feeding system.

Note that one embodiment of the present invention is not limited to the above technical field. The technical field of the invention disclosed in this specification and the like relates to an object, a method, or a manufacturing method. One embodiment of the present invention also relates to a process, a machine, manufacture, or a composition of matter. Thus, more specifically, examples of the technical field of one embodiment of the present invention disclosed in this specification include a semiconductor device, a display device, a light-emitting device, a power storage device, an imaging device, a memory device, a driving method thereof, and a manufacturing method thereof.

### BACKGROUND ART

Methods for wirelessly charging a battery have been developed. Typical examples of the methods include an electromagnetic coupling method (also referred to as an electromagnetic induction method), an electromagnetic resonance method (also referred to as an electromagnetic resonance coupling method), and an electric wave method (also referred to as a microwave method).

In the case of the electromagnetic coupling method and the electromagnetic resonance method among the wireless power-feeding methods, a way of increasing the transmission efficiency in wireless power feeding is to optimize the positional relationship between a power-receiving coil included in a device that receives power (hereinafter, a power-receiving device) and a power-feeding coil included in a device that feeds power (hereinafter, a power-feeding device). This has encouraged the development of techniques for optimizing the positional relationship between a power-receiving coil and a power-feeding coil by moving the power-feeding coil in accordance with the position of the power-receiving coil.

Patent Document 1 discloses an electromagnetic resonance power-feeding device that has a function of sensing the position of a power-receiving coil included in a power-receiving device and moving a power-feeding coil in accordance with the position of the power-receiving coil.

Patent Document 2 discloses an electromagnetic coupling power-feeding device that has a function of sensing the position of a power-receiving coil included in a power-receiving device and moving a power-feeding coil in accordance with the position of the power-receiving coil.

### PRIOR ART DOCUMENT

### Patent Document

[Patent Document 1] Japanese Published Patent Application No. 2012-147659
[Patent Document 2] Japanese Published Patent Application No. 2013-240276

### SUMMARY OF THE INVENTION

### Problems to be Solved by the Invention

An object of one embodiment of the present invention is to provide a novel power-feeding device. For example, an object of one embodiment of the present invention is to increase the sensing accuracy of the position of a power-receiving coil in an electromagnetic induction power-feeding device that has a function of sensing the position of the power-receiving coil included in a power-receiving device and moving a power-feeding coil in accordance with the position of the power-receiving coil. Another object of one embodiment of the present invention is to determine an optimal position of the power-feeding coil in the power-feeding device more accurately, more easily, or more surely.

An object of one embodiment of the present invention is to provide a novel wireless power-feeding system. Another object of one embodiment of the present invention is to increase the transmission efficiency of a wireless power-feeding system. Another object of one embodiment of the present invention is to increase the convenience of a wireless power-feeding system.

The objects of one embodiment of the present invention are not limited to those listed above. The objects listed above do not preclude the existence of other objects. The other objects are objects that are not described in this section and will be described below. The other objects that are not described in this section will be derived from the description of the specification, the drawings, and the like and can be extracted from these descriptions by those skilled in the art. One embodiment of the present invention is to solve at least one object of the objects listed above and/or the other objects.

### Means for Solving the Problems

One embodiment of the present invention is a power-feeding device including a power-feeding coil, a control device, a sensing device, and a moving device, in which the power-feeding coil has a function of generating a magnetic field, the control device is electrically connected to the power-feeding coil and the sensing device and has a function of determining a position of the power-feeding coil and a function of transmitting a position control signal, the moving device has a function of receiving the position control signal and a function of moving the power-feeding coil on the basis of the position control signal, the sensing device includes a first sensing coil and a second sensing coil, the first sensing coil has a function of generating a magnetic field, and the second sensing coil has a function of sensing a change in magnetic flux density.

One embodiment of the present invention is a power-feeding device including a power-feeding coil, a control device, a sensing device, and a moving device, in which the power-feeding coil has a function of generating a magnetic field, the control device is electrically connected to the power-feeding coil and the sensing device and has a function of determining a position of the power-feeding coil and a function of transmitting a position control signal, the moving device has a function of receiving the position control signal and a function of moving the power-feeding coil on the basis of the position control signal, the sensing device includes a first coil group and a second coil group, and the second coil group is positioned in a region surrounded by any one of coils included in the first coil group.

In the power-feeding device with the above structure, more preferably, at least one of the first coil group and the second coil group includes a first sensing coil and a second sensing coil, the first sensing coil has a function of generating a magnetic field, and the second sensing coil has a function of sensing a change in magnetic flux density.

In the power-feeding device with any of the above structures, more preferably, the control device includes a neural network, the sensing data is input to an input layer of the neural network, and the control signal is output from an output layer of the neural network.

One embodiment of the present invention is a wireless power-feeding system including the power-feeding device with any of the above structures, and a power-receiving device, in which the power-receiving device includes a power storage device and a power-receiving coil, the power storage device is electrically connected to the power-receiving coil and has a function of being charged with power induced by the power-receiving coil, and the control device has a function of determining a position of the power supply coil on the basis of a position of the power-receiving coil.

### Effect of the Invention

According to one embodiment of the present invention, a novel power-feeding device can be provided. According to one embodiment of the present invention, the sensing accuracy of the position of a power-receiving coil can be increased in an electromagnetic induction power-feeding device that has a function of sensing the position of the power-receiving coil included in a power-receiving device and moving a power-feeding coil in accordance with the position of the power-receiving coil. According to one embodiment of the present invention, an optimal position of the power-feeding coil can be determined easily or surely in the power-feeding device.

According to one embodiment of the present invention, a novel wireless power-feeding system can be provided. According to one embodiment of the present invention, the transmission efficiency of a wireless power-feeding system can be increased. According to one embodiment of the present invention, the convenience of a wireless power-feeding system can be increased.

The effects of one embodiment of the present invention are not limited to those listed above. The effects listed above do not preclude the existence of other effects. The other effects are effects that are not described in this section and will be described below. The other effects that are not described in this section will be derived from the description of the specification, the drawings, and the like and can be extracted from these descriptions by those skilled in the art. One embodiment of the present invention is to have at least one effect of the effects listed above and/or the other effects. Accordingly, depending on the case, one embodiment of the present invention does not have the effects listed above in some cases.

### BRIEF DESCRIPTION OF THE DRAWINGS

FIG. 1 A block diagram and a perspective view illustrating one embodiment of the present invention.

FIG. 2 A top view and a perspective view illustrating one embodiment of the present invention.

FIG. 3 A top view and a perspective view illustrating one embodiment of the present invention.

FIG. 4 Perspective views illustrating one embodiment of the present invention.

FIG. 5 A flowchart illustrating one embodiment of the present invention.

FIG. 6 A block diagram illustrating one embodiment of the present invention.

FIG. 7 Diagrams illustrating a configuration example of a neural network.

FIG. 8 A diagram illustrating a configuration example of a semiconductor device.

FIG. 9 A diagram illustrating a configuration example of a memory circuit.

FIG. 10 A diagram illustrating a configuration example of a memory cell.

FIG. 11 A diagram illustrating a configuration example of a circuit.

FIG. 12 A timing chart.

FIG. 13 Diagrams illustrating a structure example of a transistor.

FIG. 14 A diagram showing an energy band structure.

FIG. 15 A diagram illustrating a structure example of a semiconductor device.

FIG. 16 Diagrams each illustrating a structure example of an electronic device.

FIG. 17 Diagrams each illustrating a structure example of an electronic device.

FIG. 18 A diagram illustrating a structure example of an electronic device.

### MODE FOR CARRYING OUT THE INVENTION

### Embodiment 1

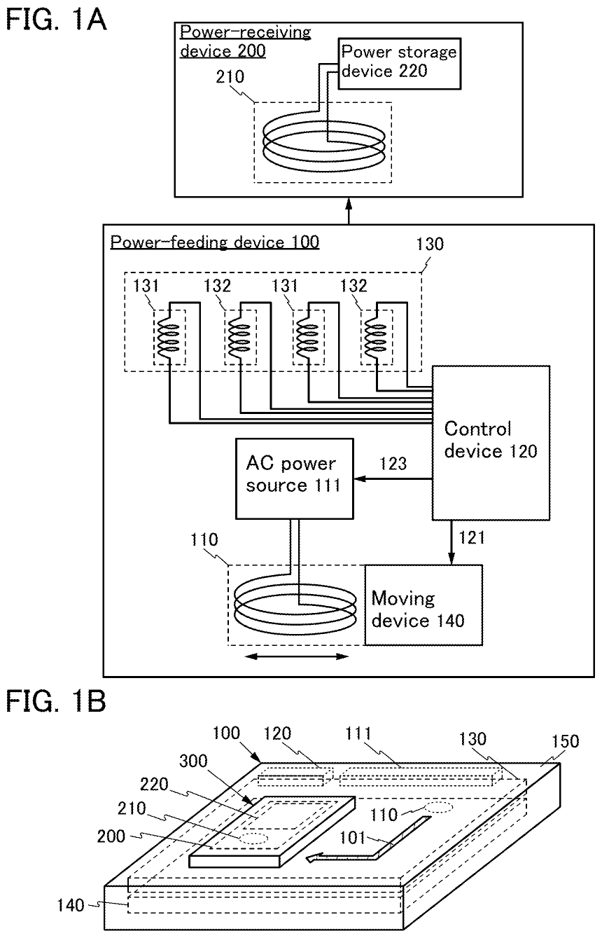

In this embodiment, a power-feeding device and a wireless power-feeding system of one embodiment of the present invention will be described with reference to FIG. 1 to FIG. 5. In this embodiment, a wireless power-feeding system including a power-feeding device 100 and a power-receiving device 200 will be described as an example of the power-feeding device and the wireless power-feeding system of one embodiment of the present invention.

FIG. 1(A) illustrates a block diagram of the power-feeding device 100 and the power-receiving device 200. FIG. 1(B) illustrates a perspective view of the power-feeding device 100 and an electronic device 300. In FIG. 1(B), the electronic device 300 is placed over the power-feeding device 100 so that a power storage device 220 is charged. The electronic device 300 incorporates the power-receiving device 200. The power-receiving device 200 includes a power-receiving coil 210.

First, a configuration of the power-feeding device 100 will be described.

As illustrated in FIG. 1(A), the power-feeding device 100 includes a power-feeding coil 110, an AC power source 111, a control device 120, a sensing device 130, and a moving device 140. As illustrated in FIG. 1(B), the power-feeding device 100 includes a housing 150 that surrounds the power-feeding coil 110, the AC power source 111, the control device 120, the sensing device 130, and the moving device 140.

In the power-feeding device 100, the sensing device 130 has a function of sensing the position of the power-receiving coil 210 and a function of transmitting a sensing signal including the sensing result. The control device 120 has a function of determining an optimal position of the power-feeding coil 110 on the basis of the sensing signal, a function of transmitting a position control signal 121 including the position data, and a function of transmitting an output control signal 123 for adjusting the output of the power-feeding coil 110 on the basis of the sensing signal. The moving device 140 has a function of moving the power-feeding coil 110 to the optimal position as indicated by an arrow 101 in FIG. 1(B) on the basis of the position control signal 121. The AC power source 111 has a function of supplying a voltage to the power-feeding coil 110 on the basis of the output control signal 123.

Thus, in the power-feeding device 100, power can be supplied to the power-receiving coil 210 after the position of the power-receiving coil 210 is sensed and the power-feeding coil 110 moves to the optimal position in accordance with the position of the power-receiving coil 210.

The control device 120 is electrically connected to the AC power source 111, the sensing device 130, and the moving device 140. The control device 120 has a function of receiving the sensing signal transmitted from the sensing device 130. The control device 120 also has a function of determining an optimal position of the power-feeding coil 110 on the basis of the sensing signal and a function of transmitting the position control signal 121 including the position data to the moving device 140. The control device 120 also has a function of transmitting the output control signal 123, which adjusts the level of the output of the power-feeding coil 110 in accordance with the sensing signal, to the AC power source 111.

The control device 120 may also have a function of transmitting the output control signal 123 including data for temporarily stopping power feeding when the actual position of the power-feeding coil 110 is found to shift from the optimal position of the power-feeding coil 110 while the power-feeding coil 110 supplies power to the power-receiving coil 210.

The control device 120 may include a full-charge detection circuit that detects the full charge of the power storage device 220 included in the power-receiving device 200. The control device 120 may also have a function of transmitting the output control signal 123 (hereinafter also referred to as an end signal), which includes data for ending power feeding, to the AC power source 111 when the full charge of the power storage device 220 is detected.

When a neural network is used for the control device 120, the optimal position of the power-feeding coil 110 can be determined more easily and more accurately on the basis of the sensing signal. A configuration of the control device 120 using a neural network will be described in detail in Embodiment 2.

The AC power source 111 is electrically connected to the power-feeding coil 110. The AC power source 111 has a function of receiving the output control signal 123. The AC power source 111 also has a function of supplying voltage to the power-feeding coil 110 on the basis of the output control signal 123. Furthermore, the AC power source 111 has a function of temporarily stopping supplying voltage to the power-feeding coil 110 on the basis of the output control signal 123.

The power-feeding coil 110 has a function of moving with the operation of the moving device 140 and a function of generating a magnetic field with a voltage supplied from the AC power source 111. Hence, the power-feeding coil 110 can supply power to the power-receiving coil 210 after having moved to an optimal position in accordance with the position of the power-receiving coil 210.

Note that the power-feeding device 100 may include one power-feeding coil 110 or a plurality of power-feeding coils 110. The power-feeding device 100 including a plurality of power-feeding coils 110 can supply power to a plurality of power-receiving devices.

As illustrated in FIG. 1(A), the sensing device 130 includes a plurality of sensing coils. The sensing device 130 is, for example, a printed circuit board, and the sensing coils are made with a printed wiring formed over the circuit board. Alternatively, the sensing device 130 may be constituted by a substrate and a small coil, chip inductor, or the like provided over the substrate.

The arrangement, shape, size, and the like of the sensing coils will be described in detail later. The sensing coils included in the sensing device 130 have a function of sensing the position of the power-receiving coil 210 and transmitting a sensing signal including the sensing result to the control device 120. The position of the power-receiving coil 210 can be sensed by sensing a change in the magnetic flux density around the sensing coils. Note that all of the sensing coils included in the sensing device 130 may have the same function or some of the sensing coils included in the sensing device 130 may have a function different from that of the other sensing coils included in the sensing device 130.

FIG. 1(A) shows an example in which the sensing device 130 includes sensing coils 131 and sensing coils 132 that have different functions. The sensing coils 131 have a function of generating a magnetic field. The sensing coils 132 have a function of sensing a change in magnetic flux density and transmitting a sensing signal to the control device 120.

Note that the sensing coils 131 generate a magnetic field in order to sense the position of the power-receiving coil 210; this purpose is different from that for the power-feeding coil 110 to generate a magnetic field. This means that the maximum intensity of the magnetic field generated by the sensing coils 131 is smaller than the maximum intensity of the magnetic field generated by the power-feeding coil 110 for power feeding.

As described above, a neural network is preferably used for the control device 120 because an optimal position of the power-feeding coil 110 can be surely determined even with a complicated sensing signal.

As illustrated in FIG. 1(A), the moving device 140 has a function of receiving the position control signal 121 and a function of moving the power-feeding coil 110 on the basis of the position control signal 121. Note that the power-feeding coil 110 moves in parallel with a substrate and the like included in the sensing device 130. The structure of the moving device 140 will be described in detail later.

The above is the description of the configuration of the power-feeding device 100.

Next, a configuration of the power-receiving device 200 will be described.

As illustrated in FIG. 1(A), the power-receiving device 200 includes the power storage device 220 and the power-receiving coil 210. The power-receiving device 200 may be incorporated in the electronic device 300 as illustrated in FIG. 1(B).

The power-receiving coil 210 has a function of receiving power through a magnetic field generated by the power-feeding coil 110 included in the power-feeding device 100.

The power storage device 220 is electrically connected to the power-receiving coil 210 and has a function of being charged with power received by the power-receiving coil 210.

The above is the description of the configuration of the power-receiving device 200.

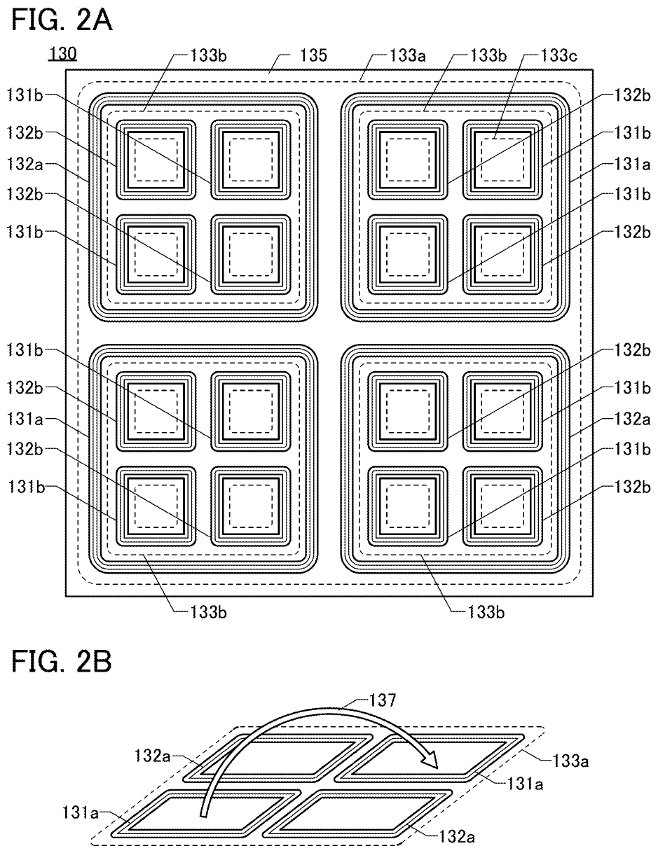

Next, the sensing coils included in the sensing device 130 will be described in detail with reference to FIG. 2.

The sensing coils included in the sensing device 130 are classified into any one of a first sensing coil group to an N-th sensing coil group (N is a natural number of 2 or more). Some of sensing coils classified into an n-th sensing coil group (n is a natural number of 2 to N) are positioned in a region surrounded by any one of sensing coils classified into an (n−1)-th sensing coil group.

Such a structure inhibits interference of the magnetic field among sensing coils classified into different groups, allowing a more stable magnetic field to be generated among sensing coils classified into the same group. In addition, a change in magnetic flux density among sensing coils classified into the same group can be sensed more accurately.

For example, in the case where the sensing device 130 includes the sensing coils 131 that have a function of generating a magnetic field and the sensing coils 132 that have a function of sensing a change in magnetic flux density and transmitting a sensing signal to the control device 120, a more stable magnetic field can be generated among the sensing coils 131 classified into the same group. Also in that case, a change in magnetic flux density among the sensing coils 132 classified into the same group can be sensed more accurately. Thus, such a structure can increase the sensing accuracy of the sensing device.

FIG. 2(A) illustrates an example of the top view of the sensing device 130. FIG. 2(B) illustrates a perspective view of part of the sensing device 130.

FIG. 2 shows an example in which the sensing coils included in the sensing device 130 are classified into any one of a first coil group and a second sensing coil group. FIG. 2 also shows an example in which the sensing device 130 includes the sensing coils 131 that have a function of generating a magnetic field and the sensing coils 132 that have a function of sensing a change in magnetic flux density and transmitting a sensing signal to the control device 120.

The sensing device 130 illustrated in FIG. 2(A) includes a substrate 135, two sensing coils 131a, two sensing coils 132a, eight sensing coils 131b, and eight sensing coils 132b. The sensing coils 131a, the sensing coils 132a, the sensing coils 131b, and the sensing coils 132b are printed wirings formed over the substrate 135.

Note that in FIG. 2(A), the sensing coils 131a and 132a are illustrated as specific examples of the sensing coils that belong to the first sensing coil group. The sensing coils 131b and the sensing coils 132b are illustrated as specific examples of the sensing coils that belong to the second sensing coil group. The sensing coils 131a and 131b are illustrated as specific examples of the sensing coils 131 that have a function of generating a magnetic field. The sensing coils 132a and the sensing coils 132b are illustrated as specific examples of the sensing coils 132 that have a function of transmitting a sensing signal to the control device 120.

In the sensing device 130 illustrated in FIG. 2(A), the sensing coils 131a and the sensing coils 132a have the same size. The two sensing coils 131a and the two sensing coils 132a are positioned in a region 133a.

Such a structure allows a stable magnetic field to be generated between the two sensing coils 131a. In addition, a change in magnetic flux density between the two sensing coils 132a can be sensed more accurately.

In the sensing device 130 illustrated in FIG. 2(A), the sensing coils 131b and the sensing coils 132b have the same size. The size of the sensing coils 131b and the sensing coils 132b is smaller than the size of the sensing coils 131a and the sensing coils 132a. Moreover, the two sensing coils 131b and the two sensing coils 132b are positioned in a region 133b that is surrounded by any one of the sensing coils 131a and the sensing coils 132a.

Such a structure allows a stable magnetic field to be generated between the two sensing coils 131b positioned in the same region 133b. In addition, a change in magnetic flux density between the two sensing coils 132b positioned in the same region 133b can be sensed more accurately.

Note that the sensing device 130 may include a sensing coil positioned in a region 133c (see FIG. 2(A)) that is surrounded by any one of the sensing coils 131b and the sensing coils 132b.

For example, four sensing coils are preferably provided in the region 133c because a change in magnetic flux density can be sensed more specifically.

In the sensing device 130 illustrated in FIG. 2(A), the two sensing coils 131a are arranged so as not to be adjacent to each other. The two sensing coils 132a are arranged so as not to be adjacent to each other. The two sensing coils 131b are arranged so as not to be adjacent to each other. The two sensing coils 132b are arranged so as not to be adjacent to each other.

FIG. 2(B) illustrates a perspective view of the region 133a, and the sensing coils 131a and the sensing coils 132a positioned in the region 133a. FIG. 2(B) also illustrates an arrow 137 representing a magnetic field that can be generated between the two sensing coils 131a. Such a structure illustrated in FIG. 2(A) allows a stable magnetic field to be generated between the two sensing coils 131a. Similarly, a stable magnetic field can be generated between the two sensing coils 131b.

As described above, with the structure illustrated in FIG. 2(A), a more stable magnetic field can be generated and a change in magnetic flux density can be sensed more accurately.

Hence, the use of the sensing device 130 enables the position of the power-receiving coil to be sensed more accurately.

Note that the configuration of the sensing device 130 is not particularly limited to that illustrated in FIG. 2(A).

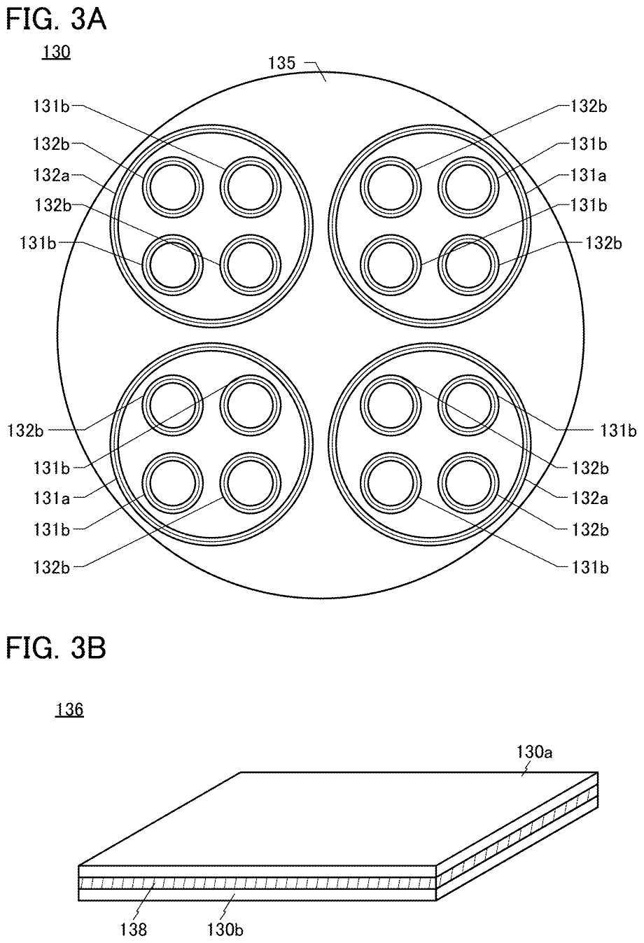

Next, modification examples of the sensing device 130 will be described with reference to FIG. 3(A) and FIG. 3(B).

FIG. 3(A) illustrates a top view of a modification example of the sensing device 130.

The modification example of the sensing device 130 illustrated in FIG. 3(A) includes a circular substrate 135, circular sensing coils 131a, circular sensing coils 132a, circular sensing coils 131b, and circular sensing coils 132b.

The sensing device 130 preferably includes the circular sensing coils as the modification example of the sensing device 130 illustrated in FIG. 3(A), in which case an undistorted magnetic field can be formed.

FIG. 3(B) illustrates a perspective view of a sensing device 136, which is a modification example of the sensing device 130. The sensing device 136 includes a sensing device 130a, a dielectric 138, and a sensing device 130b. In the sensing device 136, the sensing device 130a and the sensing device 130b are arranged so as to overlap with each other. The dielectric 138 is arranged in a position sandwiched between the sensing device 130a and the sensing device 130b.

Each of the sensing device 130a and the sensing device 130b may have a configuration similar to that of the sensing device 130 illustrated in FIG. 2.

The configuration of the sensing device 136 illustrated in FIG. 3(B) is preferable because the magnetic flux density can be sensed three-dimensionally with a plurality of stacked sensing devices. For example, the sensing device 136 is preferably used because the distance between the sensing device 136 and the power-receiving coil 210 can be easily sensed in the case where the power-receiving device 200 including the power-receiving coil 210 gets close to the power-feeding device 100.

The above is the specific description of the sensing coils included in the sensing device 130.

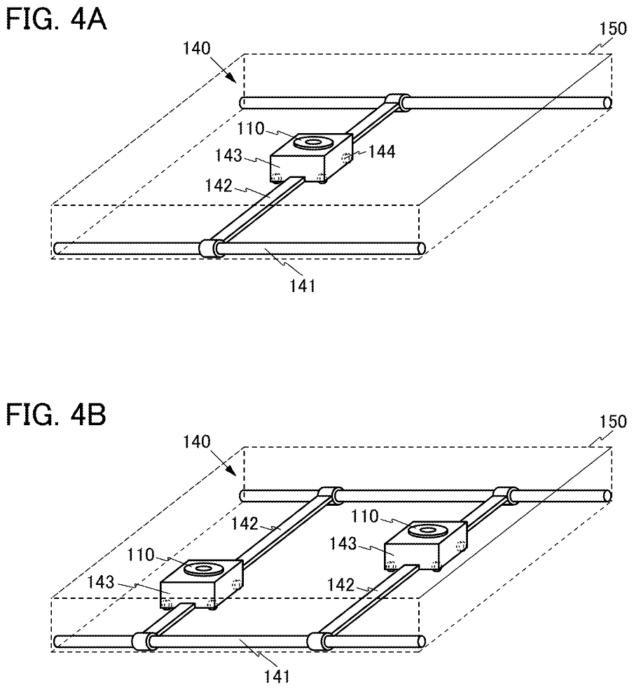

Next, the moving device 140 will be described in detail with reference to FIG. 4.

FIG. 4(A) is a perspective view illustrating an example of the moving device 140. FIG. 4(B) illustrates another example of the moving device 140.

The moving device 140 illustrated in FIG. 4(A) includes two rails 141, a rail 142, and a coil base 143. In the moving device 140, the rail 142 can move smoothly on the rails 141. The coil base 143 can move smoothly on the rail 142. The coil base 143 includes tires 144 that are driven with an electric motor. The power-feeding coil 110 can be provided on the coil base.

The moving device 140 with such a structure enables the power-feeding coil 110 to move in parallel with the substrate and the like included in the sensing device 130.

The moving device 140 illustrated in FIG. 4(B) includes the two rails 141, the two rails 142, and the two coil bases 143. The moving device 140 may have such a structure so that a plurality of power-feeding coils 110 can be moved.

The above is the specific description of the moving device 140. Note that the structure of the moving device 140 is not limited to that illustrated in FIG. 4.

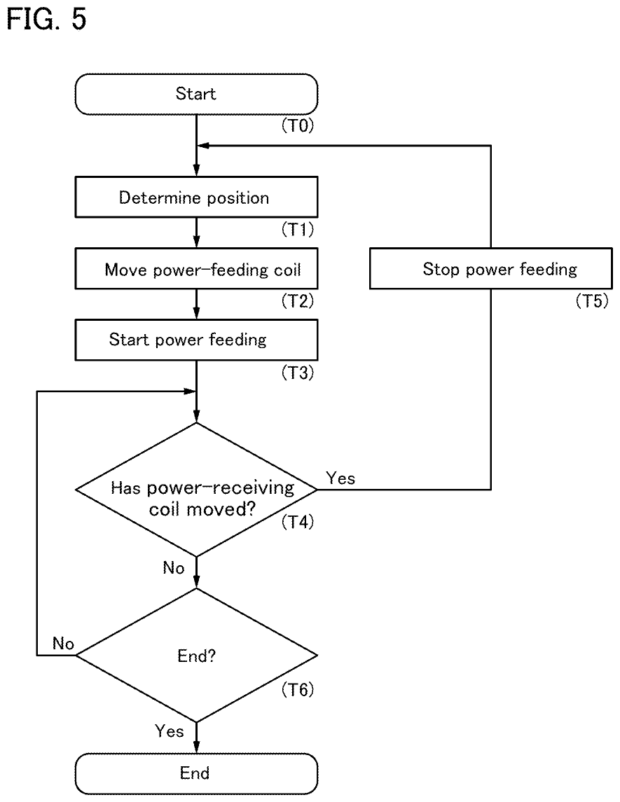

Next, an operation method of the power-feeding device 100 will be described in detail. FIG. 5 is a flowchart showing a power-feeding method of the power-feeding device 100.

First, the power-receiving device 200 is placed over the power-feeding device 100; then, the power-feeding device 100 starts to operate (see (T0) in FIG. 5).

### <<First Step>>

In a first step, an optimal position of a power-feeding coil is determined (see (T1) in FIG. 5). As described above, the optimal position of the power-feeding coil 110 can be determined when a sensing signal transmitted from the sensing device 130 is processed in the control device 120.

### <<Second Step>>

In a second step, the power-feeding coil 110 moves (see (T2) in FIG. 5). As described above, the moving device 140 has a function of moving the power-feeding coil 110.

### <<Third Step>>

In a third step, power feeding starts (see (T3) in FIG. 5). As described above, the power-feeding coil 110 has a function of inducing electromotive force.

### <<Fourth Step>>

In a fourth step, whether the power-receiving coil 210 has moved is determined (see (T4) in FIG. 5). When the power-receiving coil 210 is determined to have moved in a position different from that at the start of power feeding, the operation goes to a fifth step; when the power-receiving coil 210 is determined not to have moved from the position at the start of power feeding, the operation goes to a sixth step.

Note that the power-receiving coil 210 is expected to move with, for example, oscillation of the power-receiving device 200 including the power-receiving coil 210.

### <<Fifth Step>>

In the fifth step, the power-feeding device 100 temporarily stops power feeding; then, the operation goes to the first step (see (T5) in FIG. 5). Accordingly, even when the positional relationship between the power-receiving coil 210 and the power-feeding coil 110 changes during power feeding, unnecessary release of power can be prevented.

In the operation method of the power-feeding device 100, power feeding is not necessarily stopped temporarily in the fifth step. For example, power feeding may continue after the output is lowered, or the first step may be selected after the fourth step without passing through the fifth step. Such a control of the output of the power-feeding coil 110 can be performed with the output control signal 123 that is transmitted from the control device 120 to the AC power source 111.

### <<Sixth Step>>

In the sixth step, power feeding is ended when the AC power source 111 receives an end signal, whereas the operation goes to the fourth step when the AC power source 111 does not receive an end signal (see (T6) in FIG. 5).

The end signal is transmitted from the control device 120 when, for example, the power-receiving device 200 goes away from the power-feeding device or the power storage device 220 included in the power-receiving device 200 is fully charged.

The above is the power-feeding method of the power-feeding device 100.

This embodiment can be combined with the description of the other embodiments as appropriate.

### Embodiment 2

Described in this embodiment is a configuration example of the wireless power-feeding system described in the above embodiment that uses artificial intelligence (AI).

Note that artificial intelligence is a general term of computers that resemble the intelligence of human beings. In this specification and the like, artificial intelligence includes an artificial neural network (ANN). The artificial neural network is a circuit that resembles a neural network composed of neurons and synapses. In this specification and the like, the term “neural network” particularly refers to an artificial neural network.

### Configuration Example of Control Circuit

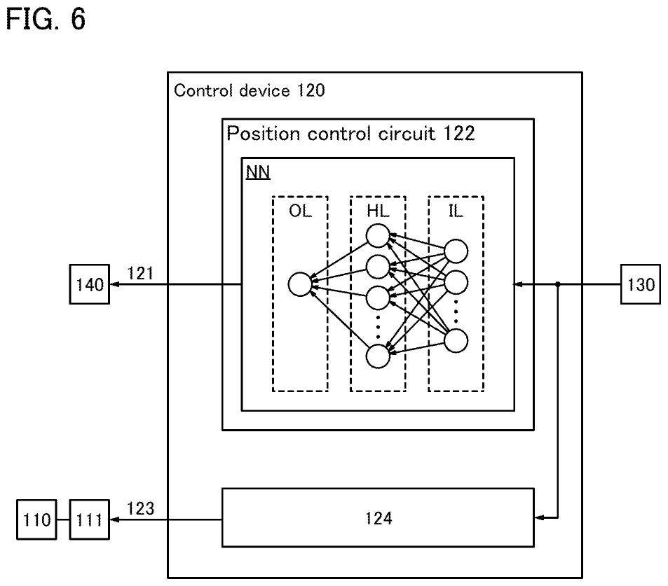

FIG. 6 illustrates a configuration example of the control device 120.

The control device 120 illustrated in FIG. 6 includes a position control circuit 122 and an output control circuit 124.

The position control circuit 122 and the output control circuit 124 each have a function of receiving a sensing signal transmitted from the sensing device 130. The position control circuit 122 also has a function of transmitting the position control signal 121. The position control circuit 122 includes a neural network NN. The output control circuit 124 also has a function of transmitting the output control signal 123.

The neural network NN includes an input layer IL, an output layer OL, and a hidden layer (middle layer) HL. Sensing data acquired by the sensing device 130 is input to the input layer IL.

The output layer OL, the input layer IL, and the hidden layer HL each include one or a plurality of units (neuron circuits), and the output from each unit is supplied to units provided in different layers through weights (connection strength). Note that the number of units in each layer can be set as appropriate. The neural network NN may be a network including a plurality of hidden layers HL (DNN: deep neural network). Learning in the deep neural network is referred to as deep learning in some cases.

A function of determining the optimal position of the power-feeding coil 110 on the basis of sensing data is added to the neural network NN by learning. When data corresponding to the sensing data is input to the input layer of the neural network NN, arithmetic processing is performed in each layer. The arithmetic processing in each layer is performed by, for example, product-sum operation of output from the units of the previous layer and weight coefficients. Note that connection between the layers may be full connection in which all the units are connected to each other or partial connection in which some of the units are connected to each other. Then, data corresponding to the results that determine the optimal position of the power-feeding coil 110 is output from the output layer OL.

When the neural network NN is used for the position control circuit 122 in this manner, the optimal position of the power-feeding coil 110 can be determined on the basis of the sensing signal more easily and more accurately.

### Configuration Examples of Neural Network

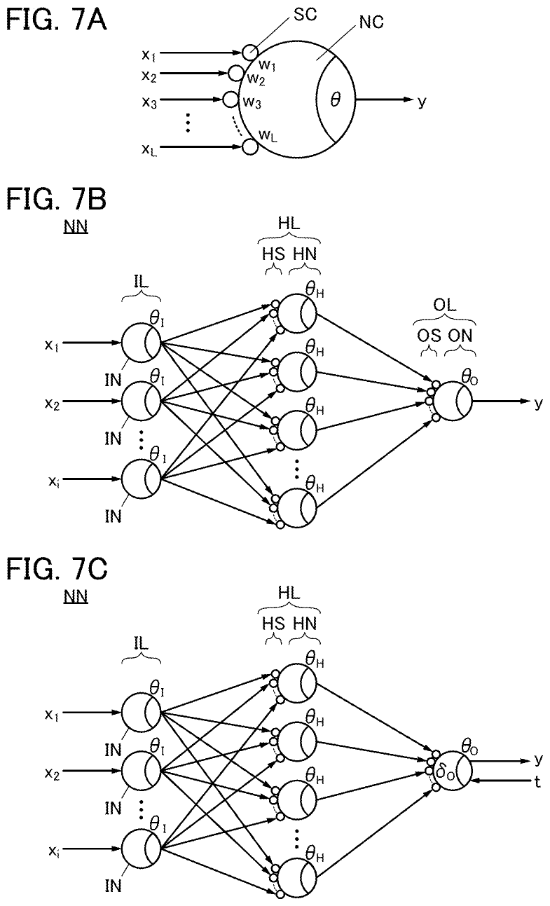

Next, more specific configuration examples of the neural network NN will be described. FIG. 7 illustrates configuration examples of the neural network. The neural network includes neuron circuits NC and synapse circuits SC provided between the neuron circuits NC.

FIG. 7(A) illustrates a configuration example of the neuron circuit NC and the synapse circuits SC. Input data x₁ to x_{L} (L is a natural number) are input to the synapse circuits SC. In addition, the synapse circuits SC each have a function of storing a weight coefficient wₖ (k is an integer greater than or equal to 1 and less than or equal to L). The weight coefficient wₖ corresponds to the connection strength between the neuron circuits NC.

When the input data x₁ to x_{L} are input to the synapse circuits SC, the sum of the products (xₖwₖ) for k=1 to L (x₁w₁+x₂w₂+ . . . +x_{L}w_{L}) of input data xₖ input to the synapse circuit SC and the weight coefficient wₖ stored in the synapse circuit SC, that is, a value obtained by the product-sum operation of xₖ and wₖ is supplied to the neuron circuit NC. When the value is larger than the threshold θ of the neuron circuit NC, the neuron circuit NC outputs a high-level signal. This phenomenon is referred to as firing of the neuron circuit NC.

FIG. 7(B) shows a model of a hierarchical neural network using the neuron circuits NC and the synapse circuits SC. The neural network includes the input layer IL, the hidden layer HL, and the output layer OL. The input layer IL includes input neuron circuits IN. The hidden layer HL includes hidden synapse circuits HS and hidden neuron circuits HN. The output layer OL includes output synapse circuits OS and output neuron circuits ON. The thresholds θ of the input neuron circuit IN, the hidden neuron circuit HN, and the output neuron circuit ON are referred to as θ_{I}, θ_{H}, and θ_{O}, respectively.

Data x₁ to xᵢ (i is a natural number) corresponding to sensing signals are supplied to the input layer IL, and output of the input layer IL is supplied to the hidden layer HL. Then, a value obtained by the product-sum operation using the output data of the input layer IL and the weight coefficients w that are held in the hidden synapse circuits HS is supplied to the hidden neuron circuits HN. A value obtained by the product-sum operation using the output of the hidden neuron circuit HN and the weight coefficients w that are held in the output synapse circuits OS is supplied to the output neuron circuits ON. Then, data y corresponding to the optimal position of the power-feeding coil 110 is output.

Thus, the neural network illustrated in FIG. 7(B) has a function of determining the optimal position of the power-feeding coil 110 on the basis of the sensing data.

A gradient descent method or the like can be used for learning in the neural network, and a backpropagation method can be used for calculation of a gradient. FIG. 7(C) illustrates a model of the neural network that performs supervised learning using a backpropagation method.

A backpropagation method is one of methods for changing a weight coefficient of a synapse circuit so that the error between output data from a neural network and teacher data is reduced. Specifically, a weight coefficient w of the hidden synapse circuit HS is changed in accordance with an error δ_{O} that is determined on the basis of the output data (data y) and the teacher data (data t). In addition, a weight coefficient w of a synapse circuit SC in the previous stage is changed in accordance with the amount of change in the weight coefficient w of the hidden synapse circuit HS. In this manner, weight coefficients of the synapse circuits SC are sequentially changed on the basis of the teacher data, so that the neural network NN can perform learning.

Note that one hidden layer HL is illustrated in FIGS. 7(B) and 7(C) but the number of the hidden layers HL may be two or more. Thus, deep learning can be performed.

This embodiment can be combined with the description of the other embodiments as appropriate.

### Embodiment 3

In this embodiment, configuration examples of a semiconductor device that can be used in the neural networks described in Embodiment 2 will be described.

In the case where a neural network includes hardware, product-sum operation in the neural network can be performed with the use of a product-sum operation element. In this embodiment, configuration examples of a semiconductor device that can be used as a product-sum operation element in the neural network NN are described.

### Configuration Example of Semiconductor Device

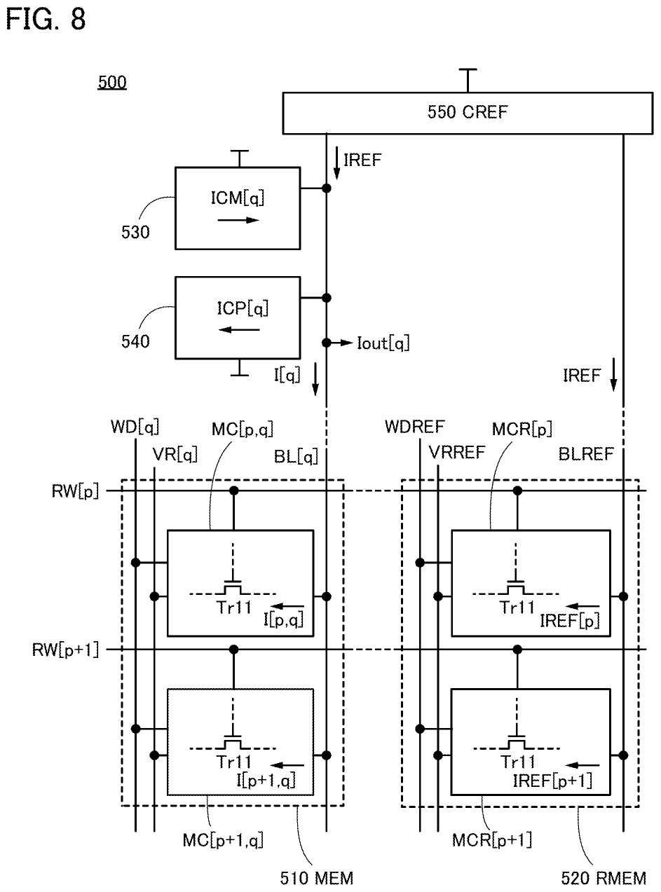

FIG. 8 illustrates a configuration example of a semiconductor device 500. The semiconductor device 500 illustrated in FIG. 8 includes a memory circuit 510 (MEM), a reference memory circuit 520 (RMEM), a circuit 530, and a circuit 540. The semiconductor device 500 may further include a current supply circuit 550 (CREF).

The memory circuit 510 (MEM) includes memory cells MC such as a memory cell MC [p, q] and a memory cell MC[p+1, q]. The memory cells MC each include an element that has a function of converting an input potential into current. As the element having such a function, an active element such as a transistor can be used, for example. FIG. 8 illustrates an example where the memory cells MC each include a transistor Tr11.

A first analog potential is input to the memory cells MC through a wiring WD such as a wiring WD[q]. The first analog potential corresponds to first analog data. The memory cells MC each have a function of generating a first analog current corresponding to the first analog potential. Specifically, a drain current of the transistor Tr11 that is obtained when the first analog potential is supplied to a gate of the transistor Tr11 can be used as the first analog current. Hereinafter, a current flowing in the memory cell MC[p, q] is denoted by I[p, q], and a current flowing in the memory cell MC[p+1, q] is denoted by I[p+1, q].

Note that the drain current of the transistor Tr11 operating in a saturation region is not dependent on the voltage between its source and drain and is controlled by the difference between its gate voltage and threshold voltage. Thus, the transistor Tr11 desirably operates in a saturation region. The gate voltage and the voltage between the source and the drain of the transistor Tr11 are each appropriately set to a voltage at which the transistor Tr11 operates in a saturation region.

Specifically, in the semiconductor device 500 illustrated in FIG. 8, a first analog potential Vx[p, q] or a potential corresponding to the first analog potential Vx[p, q] is input to the memory cell MC[p, q] through the wiring WD[q]. The memory cell MC[p, q] has a function of generating a first analog current corresponding to the first analog potential Vx[p, q]. This means that the current I[p, q] in the memory cell MC[p, q] corresponds to the first analog current, in this case.

Specifically, in the semiconductor device 500 illustrated in FIG. 8, a first analog potential Vx[p+1, q] or a potential corresponding to the first analog potential Vx[p+1, q] is input to the memory cell MC[p+1, q] through the wiring WD[q]. The memory cell MC[p+1, q] has a function of generating a first analog current corresponding to the first analog potential Vx[p+1, q]. This means that the current I[p+1, q] in the memory cell MC[p+1, q] corresponds to the first analog current, in this case.

The memory cells MC each have a function of holding the first analog potential. In other words, by holding the first analog potential, the memory cells MC each have a function of holding the first analog current corresponding to the first analog potential.

A second analog potential is input to the memory cells MC through a wiring RW such as a wiring RW[p] or a wiring RW[p+1]. The second analog potential corresponds to second analog data. The memory cells MC each have a function of adding the second analog potential or a potential corresponding to the second analog potential to the first analog potential that has been held and a function of holding a third analog potential obtained by the addition. The memory cells MC each also have a function of generating a second analog current corresponding to the third analog potential. In other words, by holding the third analog potential, the memory cells MC each have a function of holding the second analog current corresponding to the third analog potential.

Specifically, in the semiconductor device 500 illustrated in FIG. 8, a second analog potential Vw[p, q] is input to the memory cell MC[p, q] through the wiring RW[p]. The memory cell MC[p, q] has a function of holding a third analog potential corresponding to the first analog potential Vx[p, q] and the second analog potential Vw[p, q]. The memory cell MC[p, q] also has a function of generating a second analog current corresponding to the third analog potential. This means that the current I[p, q] in the memory cell MC[p, q] corresponds to the second analog current, in this case.

Furthermore, in the semiconductor device 500 illustrated in FIG. 8, a second analog potential Vw[p+1, q] is input to the memory cell MC[p+1, q] through the wiring RW[p+1]. The memory cell MC[p+1, q] has a function of holding a third analog potential corresponding to the first analog potential Vx[p+1, q] and the second analog potential Vw[p+1, q]. The memory cell MC[p+1, q] also has a function of generating a second analog current corresponding to the third analog potential. This means that the current I[p+1, q] in the memory cell MC[p+1, q] corresponds to the second analog current, in this case.

The current I[p, q] flows between a wiring BL[q] and a wiring VR[q] through the memory cell MC[p, q]. The current I[p+1, q] flows between the wiring BL[q] and the wiring VR[q] through the memory cell MC[p+1, q]. Accordingly, a current I[q], which corresponds to the sum of the current I[p, q] and the current I[p+1, q], flows between the wiring BL[q] and the wiring VR[q] through the memory cell MC[p, q] and the memory cell MC[p+1, q].

The reference memory circuit 520 (RMEM) includes memory cells MCR such as a memory cell MCR[p] and a memory cell MCR[p+1]. A first reference potential VPR is input to the memory cells MCR through a wiring WDREF. The memory cells MCR each have a function of generating a first reference current corresponding to the first reference potential VPR. Note that hereinafter, a current flowing in the memory cell MCR[p] is denoted by IREF[p], and a current flowing in the memory cell MCR[p+1] is denoted by IREF[p+1].

Specifically, in the semiconductor device 500 illustrated in FIG. 8, the first reference potential VPR is input to the memory cell MCR[p] through the wiring WDREF. The memory cell MCR[p] has a function of generating the first reference current corresponding to the first reference potential VPR. This means that the current IREF[p] in the memory cell MCR[p] corresponds to the first reference current, in this case.

Furthermore, in the semiconductor device 500 illustrated in FIG. 8, the first reference potential VPR is input to the memory cell MCR[p+1] through the wiring WDREF. The memory cell MCR[p+1] has a function of generating the first reference current corresponding to the first reference potential VPR. This means that the current IREF[p+1] in the memory cell MCR[p+1] corresponds to the first reference current, in this case.

The memory cells MCR each have a function of holding the first reference potential VPR. In other words, by holding the first reference potential VPR, the memory cells MCR each have a function of holding the first reference current corresponding to the first reference potential VPR.

Moreover, the second analog potential is input to the memory cells MCR through the wiring RW such as the wiring RW[p] or the wiring RW[p+1]. The memory cells MCR each have a function of adding the second analog potential or a potential corresponding to the second analog potential to the first reference potential VPR that has been held and holding a second reference potential obtained by the addition. The memory cells MCR each also have a function of generating a second reference current corresponding to the second reference potential. In other words, by holding the second reference potential, the memory cells MCR each have a function of holding the second reference current corresponding to the second reference potential.

Specifically, in the semiconductor device 500 illustrated in FIG. 8, the second analog potential Vw[p, q] is input to the memory cell MCR[p] through the wiring RW[p]. The memory cell MCR[p] has a function of holding a second reference potential corresponding to the first reference potential VPR and the second analog potential Vw[p, q]. The memory cell MCR[p] also has a function of generating the second reference current corresponding to the second reference potential. This means that the current IREF [p] in the memory cell MCR[p] corresponds to the second reference current, in this case.

Furthermore, in the semiconductor device 500 illustrated in FIG. 8, the second analog potential Vw[p+1, q] is input to the memory cell MCR[p+1] through the wiring RW[p+1]. The memory cell MCR[p+1] has a function of holding a second reference potential corresponding to the first reference potential VPR and the second analog potential Vw[p+1, q]. The memory cell MCR[p+1] also has a function of generating the second reference current corresponding to the second reference potential. This means that the current IREF[p+1] in the memory cell MCR[p+1] corresponds to the second reference current, in this case.

The current IREF[p] flows between a wiring BLREF and a wiring VRREF through the memory cell MCR[p]. The current IREF[p+1] flows between the wiring BLREF and the wiring VRREF through the memory cell MCR[p+1]. Accordingly, a current IREF, which corresponds to the sum of the current IREF[p] and the current IREF[p+1], flows between the wiring BLREF and the wiring VRREF through the memory cell MCR[p] and the memory cell MCR[p+1].

The current supply circuit 550 has a function of supplying a current with the same value as the current IREF that flows through the wiring BLREF or supplying a current corresponding to the current IREF to the wiring BL. In the case where the current I[q] that flows between the wiring BL[q] and the wiring VR[q] through the memory cell MC[p, q] and the memory cell MC[p+1, q] is different from the current IREF that flows between the wiring BLREF and the wiring VRREF through the memory cell MCR[p] and the memory cell MCR[p+1] and thus an offset current is set as described later, a current corresponding to the difference flows in the circuit 530 or the circuit 540. The circuit 530 serves as a current source circuit, and the circuit 540 serves as a current sink circuit.

Specifically, in the case where the current I[q] is higher than the current IREF, the circuit 530 has a function of generating a current ΔI[q] that corresponds to the difference between the current I[q] and the current IREF. The circuit 530 also has a function of supplying the generated current ΔI[q] to the wiring BL[q]. This means that the circuit 530 has a function of holding the current ΔI[q].

In the case where the current I[q] is lower than the current IREF, the circuit 540 has a function of generating the current ΔI[q] that corresponds to the difference between the current I[q] and the current IREF. The circuit 540 also has a function of drawing the generated current ΔI[q] from the wiring BL[q]. This means that the circuit 540 has a function of holding the current ΔI[q].

Next, an operation example of the semiconductor device 500 illustrated in FIG. 8 will be described.

First, a potential corresponding to the first analog potential is stored in the memory cell MC[p, q]. Specifically, a potential VPR-Vx[p, q], which is obtained by subtracting the first analog potential Vx[p, q] from the first reference potential VPR, is input to the memory cell MC[p, q] through the wiring WD[q]. The memory cell MC[p, q] holds the potential VPR-Vx[p, q]. In addition, the memory cell MC[p, q] generates the current I[p, q] that corresponds to the potential VPR-Vx[p, q]. The first reference potential VPR is, for example, a high-level potential that is higher than a ground potential. Specifically, the first reference potential VPR is desirably higher than a ground potential and as high as or lower than a high-level potential VDD that is supplied to the current supply circuit 550.

Furthermore, the first reference potential VPR is stored in the memory cell MCR[p]. Specifically, the first reference potential VPR is input to the memory cell MCR[p] through the wiring WDREF. The memory cell MCR[p] holds the first reference potential VPR. In addition, the memory cell MCR[p] generates the current IREF[p] that corresponds to the first reference potential VPR.

A potential corresponding to the first analog potential is stored in the memory cell MC[p+1, q]. Specifically, a potential VPR−Vx[p+1, q], which is obtained by subtracting the first analog potential Vx[p+1, q] from the first reference potential VPR, is input to the memory cell MC[p+1, q] through the wiring WD[q]. The memory cell MC[p+1, q] holds the potential VPR−Vx[p+1, q]. In addition, the memory cell MC[p+1, q] generates the current I[p+1, q] that corresponds to the potential VPR−Vx[p+1, q].

Furthermore, the first reference potential VPR is stored in the memory cell MCR[p+1]. Specifically, the first reference potential VPR is input to the memory cell MCR[p+1] through the wiring WDREF. The memory cell MCR[p+1] holds the first reference potential VPR. In addition, the memory cell MCR[p+1] generates the current IREF[p+1] that corresponds to the first reference potential VPR.

During the above operation, the wiring RW[p] and the wiring RW[p+1] are each set to a base potential. As a base potential, for example, a ground potential or a low-level potential VSS that is lower than a base potential can be used. Alternatively, a potential between the potential VSS and the potential VDD is preferably used as a base potential, in which case the potential of the wiring RW can be higher than the ground potential regardless of whether the second analog potential Vw is positive or negative, which enables easy generation of signals and multiplication of either positive or negative analog data.

As a result of the above operation, a current corresponding to the sum of currents generated in the memory cells MC connected to the wiring BL[q] flows through the wiring BL[q]. Specifically, in FIG. 8, the current I[q], which is the sum of the current I[p, q] generated in the memory cell MC[p, q] and the current I[p+1, q] generated in the memory cell MC[p+1, q], flows. In addition, as a result of the above operation, a current corresponding to the sum of currents generated in the memory cells MCR connected to the wiring BLREF flows through the wiring BLREF. Specifically, in FIG. 8, the current IREF, which is the sum of the current IREF[p] generated in the memory cell MCR[p] and the current IREF[p+1] generated in the memory cell MCR[p+1], flows.

Next, an offset current Ioffset[q], which is obtained from the difference between the current I[q] obtained by the input of the first analog potential and the current IREF obtained by the input of the first reference potential, is held in the circuit 530 or the circuit 540 while the potentials of the wiring RW[p] and the wiring RW[p+1] are kept at base potentials.

Specifically, when the current I[q] is higher than the current IREF, the circuit 530 supplies the current Ioffset[q] to the wiring BL[q]. This means that a current ICM[q] that flows in the circuit 530 corresponds to the current Ioffset[q]. The value of the current ICM[q] is held in the circuit 530. When the current I[q] is lower than the current IREF, the circuit 540 draws the current Ioffset[q] from the wiring BL[q]. This means that a current ICP[q] that flows in the circuit 540 corresponds to the current Ioffset[q]. The value of the current ICP[q] is held in the circuit 540.

Then, the second analog potential or a potential corresponding to the second analog potential is stored in the memory cell MC[p, q] so as to be added to the first analog potential that has been held in the memory cell MC [p, q] or a potential corresponding to the first analog potential.

Specifically, when the potential of the wiring RW[p] is set to a potential that is higher than a base potential by Vw[p], a second analog potential Vw[p] is input to the memory cell MC[p, q] through the wiring RW[p]. The memory cell MC[p, q] holds a potential VPR−Vx[p, q]+Vw[p]. Furthermore, the memory cell MC[p, q] generates the current I[p, q] corresponding to the potential VPR−Vx[p, q]+Vw[p].

In addition, the second analog potential or the potential corresponding to the second analog potential is stored in the memory cell MC[p+1, q] so as to be added to the first analog potential that has been held in the memory cell MC[p+1, q] or a potential corresponding to the first analog potential. Specifically, when the potential of the wiring RW[p+1] is set to a potential that is higher than a base potential by Vw[p+1], a second analog potential Vw[p+1] is input to the memory cell MC[p+1, q] through the wiring RW[p+1]. The memory cell MC[p+1, q] holds a potential VPR−Vx[p+1, q]+Vw[p+1]. Furthermore, the memory cell MC[p+1, q] generates the current I[p+1, q] corresponding to the potential VPR−Vx[p+1, q]+Vw[p+1].

In the case where the transistor Tr11 that operates in a saturation region is used as an element for converting a potential into current, since the drain current of the transistor Tr11 included in the memory cell MC[p, q] corresponds to the current I[p, q], the second analog current is expressed by Formula 1 below on the assumption that Vw[p] is the potential of the wiring RW[p] and Vw[p+1] is the potential of the wiring RW[p+1]. Note that k is a coefficient and Vth is the threshold voltage of the transistor Tr11.

I[p,q]=k(Vw[p]−Vth+VPR−Vx[p,q])² (Formula 1)

Furthermore, since the drain current of the transistor Tr11 included in the memory cell MCR[p] corresponds to the current IREF[p], the second reference current is expressed by Formula 2 below.

IREF[p]=k(Vw[p]−Vth+VPR)² (Formula 2)

The current I[q], which corresponds to the sum of the current I[p, q] flowing in the memory cell MC[p, q] and the current I[p+1, q] flowing in the memory cell MC[p+1, q], is expressed as I[q]=ΣiI[p, q], and the current IREF, which corresponds to the sum of the current IREF[p] flowing in the memory cell MCR[p] and the current IREF[p+1] flowing in the memory cell MCR[p+1], is expressed as IREF=ΣiIREF[p]; accordingly, the current ΔI[q] that corresponds to the difference between the current I[q] and the current IREF is expressed by Formula 3 below.

ΔI[q]=IREF−I[q]=ΣiIREF[p]−ΣiI[p,q] (Formula 3)

From Formula 1, Formula 2, and Formula 3, the current ΔI[q] can be expressed by Formula 4 below.

ΔI[q]=Σi{k(Vw[p]−Vth+VPR)²−k(Vw[p]−Vth+VPR−Vx[p,q])²}=2kΣi(Vw[p]Vx[p,q])−2kΣi(Vth−VPR)·Vx[p,q]−kΣiVx[p,q]² (Formula 4)

The term 2kΣi(Vw[p]·Vx[p, q]) in Formula 4 corresponds to the sum of the product of the first analog potential Vx[p, q] and the second analog potential Vw[p] and the product of the first analog potential Vx[p+1, q] and the second analog potential Vw[p+1].

If the current Ioffset[q] is defined as the current ΔI[q] at the time when the potential of the wiring RW[p] is all set to a base potential, that is, when the second analog potential Vw[p] is 0 and the second analog potential Vw[p+1] is 0, Formula 5 below can be obtained from Formula 4.

Ioffset[q]=−2kΣi(Vth−VPR)·Vx[p,q]−kΣiVx[p,q]² (Formula 5)

According to Formula 3 to Formula 5, 2kΣi(Vw[p]·Vx[p, q]) that corresponds to the product-sum of the first analog data and the second analog data is expressed by Formula 6 below.

2kΣi(Vw[p]Vx[p,q])=IREF−I[q]−Ioffset[q] (Formula 6)

When the potential of the wiring RW[p] is Vw[p] and the potential of the wiring RW[p+1] is Vw[p+1], a current Iout[q] that flows from the wiring BL[q] is expressed by IREF−I[q]−Ioffset[q], where I[q] is the sum of currents flowing in the memory cells MC, IREF is the sum of currents flowing in the memory cells MCR, and Ioffset[q] is a current flowing in the circuit 530 or the circuit 540. According to Formula 6, the current Iout[q] is equal to 2kΣi(Vw[p]·Vx[p, q]), which corresponds to the sum of the product of the first analog potential Vx[p, q] and the second analog potential Vw[p] and the product of the first analog potential Vx[p+1, q] and the second analog potential Vw[p+1].

The transistor Tr11 desirably operates in a saturation region; however, even if the operation region of the transistor Tr11 deviates from an ideal saturation region, the transistor Tr11 is regarded as operating in a saturation region as long as there is no problem in obtaining a current that corresponds to the sum of the product of the first analog potential Vx[p, q] and the second analog potential Vw[p] and the product of the first analog potential Vx[p+1, q] and the second analog potential Vw[p+1] with an accuracy within a desired range.

According to one embodiment of the present invention, analog data can be subjected to arithmetic processing without being converted into digital data; thus, the circuit scale of a semiconductor device can be reduced. Alternatively, according to one embodiment of the present invention, analog data can be subjected to arithmetic processing without being converted into digital data; thus, the time required for the arithmetic processing of analog data can be shortened.

Alternatively, according to one embodiment of the present invention, the power consumption of a semiconductor device can be reduced while the time required for arithmetic processing of analog data is shortened.

### Configuration Example of Memory Circuit

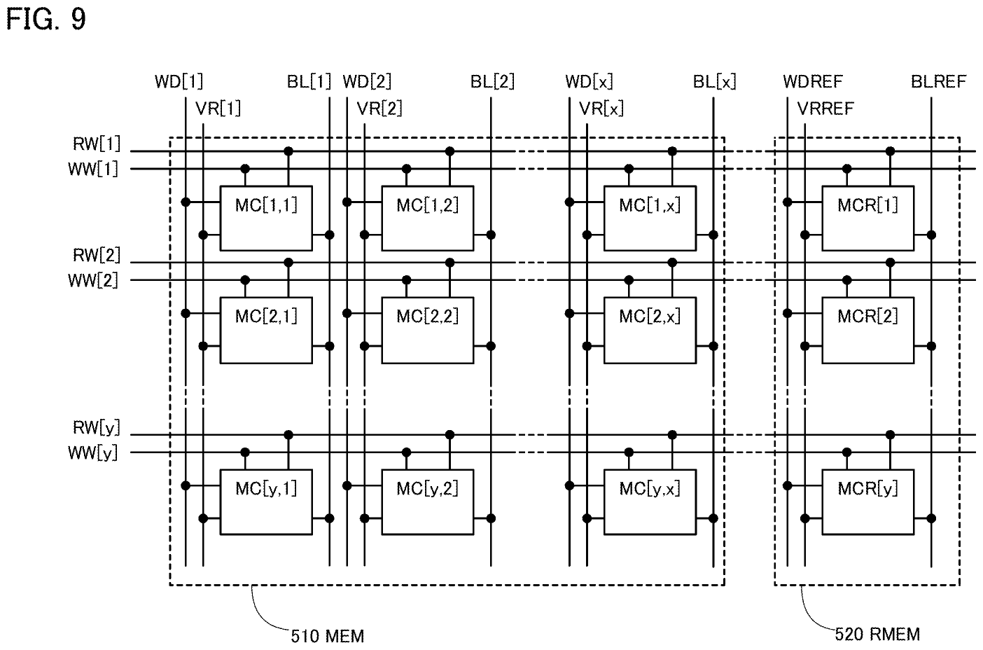

Next, a specific configuration example of the memory circuit 510 (MEM) and the reference memory circuit 520 (RMEM) will be described with reference to FIG. 9.

FIG. 9 illustrates an example where the memory circuit 510 (MEM) includes the memory cells MC in y rows and x columns (x and y are natural numbers) and the reference memory circuit 520 (RMEM) includes the memory cells MCR in y rows and one column.

Note that a source of a transistor in this specification and the like means a source region that is part of a semiconductor layer functioning as a channel formation region, a source electrode connected to the semiconductor layer, or the like. Similarly, a drain of a transistor means a drain region that is part of the semiconductor layer, a drain electrode connected to the semiconductor layer, or the like. A gate means a gate electrode or the like.

The names of a source and a drain of a transistor interchange with each other depending on the conductivity type of the transistor or levels of potentials applied to the terminals. In general, in an n-channel transistor, a terminal to which a lower potential is applied is called a source, and a terminal to which a higher potential is applied is called a drain. In a p-channel transistor, a terminal to which a lower potential is applied is called a drain, and a terminal to which a higher potential is applied is called a source. In this specification, although the connection relation of a transistor is sometimes described assuming that the source and the drain are fixed for convenience, actually, the names of the source and the drain interchange with each other depending on the relation of the potentials.

The memory circuit 510 is connected to the wiring RW, a wiring WW, the wiring WD, the wiring VR, and the wiring BL. In the example illustrated in FIG. 9, a wiring RW[1] to a wiring RW[y] are connected to the memory cells MC in the respective rows, a wiring WW[1] to a wiring WW[y] are connected to the memory cells MC in the respective rows, a wiring WD[1] to a wiring WD[x] are connected to the memory cells MC in the respective columns, and a wiring BL[1] to a wiring BL[x] are connected to the memory cells MC in the respective columns. Moreover, in the example illustrated in FIG. 9, a wiring VR[1] to a wiring VR[x] are connected to the memory cells MC in the respective columns. Note that the wiring VR[1] to the wiring VR[x] may be connected to each other.

The reference memory circuit 520 is connected to the wiring RW, the wiring WW, the wiring WDREF, the wiring VRREF, and the wiring BLREF. In the example illustrated in FIG. 9, the wiring RW[1] to the wiring RW[y] are connected to the memory cells MCR in the respective rows, the wiring WW[1] to the wiring WW[y] are connected to the memory cells MCR in the respective rows, the wiring WDREF is connected to the memory cells MCR in one column, the wiring BLREF is connected to the memory cells MCR in the one column, and the wiring VRREF is connected to the memory cells MCR in the one column. Note that the wiring VRREF may be connected to the wiring VR[1] to the wiring VR[x].

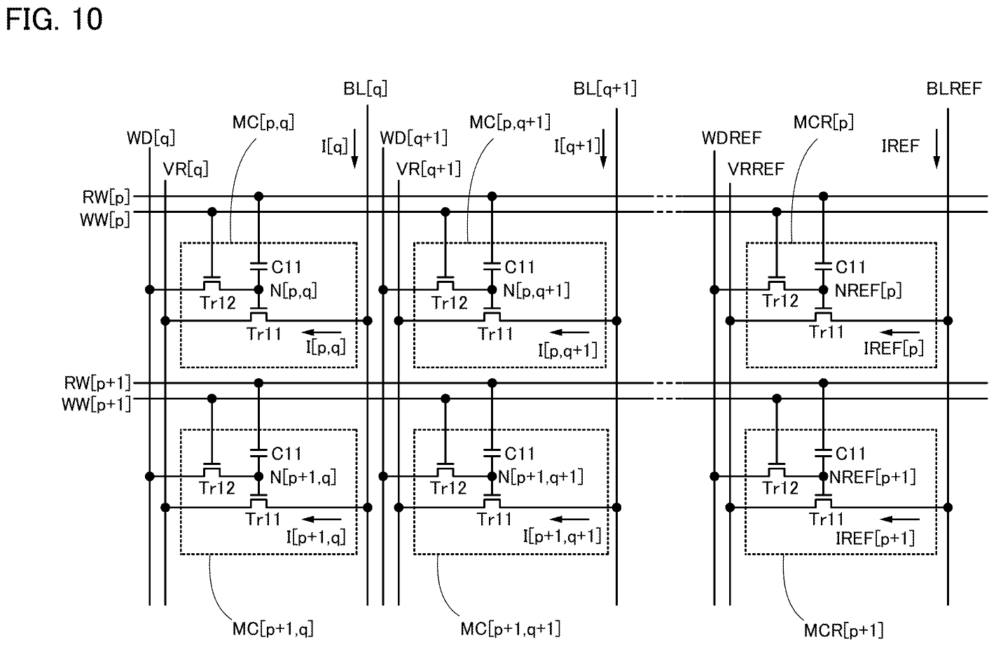

Next, FIG. 10 illustrates, as an example, a specific circuit configuration and a specific connection relation of the memory cells MC in any two rows and two columns among the memory cells MC illustrated in FIG. 9 and the memory cells MCR in any two rows and one column among the memory cells MCR illustrated in FIG. 9.

Specifically, FIG. 10 illustrates the memory cell MC[p, q] in the p-th row and the q-th column, the memory cell MC[p+1, q] in the (p+1)-th row and the q-th column, a memory cell MC[p, q+1] in the p-th row and the (q+1)-th column, and a memory cell MC[p+1, q+1] in the (p+1)-th row and the (q+1)-th column. Furthermore, FIG. 10 specifically illustrates the memory cell MCR[p] in the p-th row and the memory cell MCR[p+1] in the (p+1)-th row. Note that each of p and p+1 is any number from 1 toy, and each of q and q+1 is any number from 1 to x.

The memory cell MC[p, q], the memory cell MC[p, q+1], and the memory cell MCR[p] in the p-th row are connected to the wiring RW[p] and a wiring WW[p]. The memory cell MC[p+1, q], the memory cell MC[p+1, q+1], and the memory cell MCR[p+1] in the (p+1)-th row are connected to the wiring RW[p+1] and a wiring WW[p+1].

The memory cell MC[p, q] and the memory cell MC[p+1, q] in the q-th column are connected to the wiring WD[q], the wiring VR[q], and the wiring BL[q]. The memory cell MC[p, q+1] and the memory cell MC[p+1, q+1] in the (q+1)-th column are connected to a wiring WD[q+1], a wiring VR[q+1], and a wiring BL[q+1]. The memory cell MCR[p] in the p-th row and the memory cell MCR[p+1] in the (p+1)-th row are connected to the wiring WDREF, the wiring VRREF, and the wiring BLREF.

The memory cells MC and the memory cells MCR each include the transistor Tr11, a transistor Tr12, and a capacitor C11. The transistor Tr12 has a function of controlling the input of the first analog potential to the memory cell MC or the memory cell MCR. The transistor Tr11 has a function of generating an analog current in accordance with a potential input to its gate. The capacitor C11 has a function of adding the second analog potential or a potential corresponding to the second analog potential to the first analog potential that is held in the memory cell MC or the memory cell MCR or a potential corresponding to the first analog potential.

Specifically, in the memory cell MC illustrated in FIG. 10, a gate of the transistor Tr12 is connected to the wiring WW, one of a source and a drain is connected to the wiring WD, and the other of the source and the drain is connected to the gate of the transistor Tr11. Furthermore, one of the source and the drain of the transistor Tr11 is connected to the wiring VR, and the other of the source and the drain is connected to the wiring BL. A first electrode of the capacitor C11 is connected to the wiring RW, and a second electrode is connected to the gate of the transistor Tr11.

In addition, in the memory cell MCR illustrated in FIG. 10, the gate of the transistor Tr12 is connected to the wiring WW, one of the source and the drain is connected to the wiring WDREF, and the other of the source and the drain is connected to the gate of the transistor Tr11. Furthermore, one of the source and the drain of the transistor Tr11 is connected to the wiring VRREF, and the other of the source and the drain is connected to the wiring BLREF. The first electrode of the capacitor C11 is connected to the wiring RW, and the second electrode is connected to the gate of the transistor Tr11.

When the gate of the transistor Tr11 in the memory cell MC is called a node N, in the memory cell MC, the first analog potential is input to the node N through the transistor Tr12, and then, when the transistor Tr12 is turned off, the node N is brought into a floating state and the first analog potential or the potential corresponding to the first analog potential is held at the node N. In the memory cell MC, when the node N is brought into a floating state, the second analog potential that is input to the first electrode of the capacitor C11 is applied to the node N. As a result of the above operation, the node N can have a potential obtained by adding the second analog potential or the potential corresponding to the second analog potential to the first analog potential or the potential corresponding to the first analog potential.

Since the potential of the first electrode of the capacitor C11 is applied to the node N through the capacitor C11, the amount of change in the potential of the first electrode is not exactly the same as the amount of change in the potential of the node N, actually. Specifically, the accurate amount of change in the potential of the node N can be calculated in the following manner: a coupling coefficient uniquely determined by the capacitance value of the capacitor C11, the capacitance value of the gate capacitance of the transistor Tr11, and the capacitance value of parasitic capacitance is multiplied by the amount of change in the potential of the first electrode. In the following description, the amount of change in the potential of the first electrode is assumed to be substantially the same as the amount of change in the potential of the node N, for easy understanding.

The drain current of the transistor Tr11 is determined by the potential of the node N. Thus, when the transistor Tr12 is turned off and thus the potential of the node N is held, the value of the drain current of the transistor Tr11 is also held. The drain current is affected by the first analog potential and the second analog potential.

When the gate of the transistor Tr11 in the memory cell MCR is called a node NREF, in the memory cell MCR, the first reference potential or a potential corresponding to the first reference potential is input to the node NREF through the transistor Tr12, and then, when the transistor Tr12 is turned off, the node NREF is brought into a floating state and the first reference potential or the potential corresponding to the first reference potential is held at the node NREF. In the memory cell MCR, when the node NREF is brought into a floating state, the second analog potential that is input to the first electrode of the capacitor C11 is applied to the node NREF. As a result of the above operation, the node NREF can have a potential obtained by adding the second analog potential or the potential corresponding to the second analog potential to the first reference potential or the potential corresponding to the first reference potential.

The drain current of the transistor Tr11 is determined by the potential of the node NREF. Thus, when the transistor Tr12 is turned off and thus the potential of the node NREF is held, the value of the drain current of the transistor Tr11 is also held. The drain current is affected by the first reference potential and the second analog potential.

When the drain current flowing in the transistor Tr11 in the memory cell MC[p, q] is the current I[p, q] and the drain current flowing in the transistor Tr11 in the memory cell MC[p+1, q] is the current I[p+1, q], the sum of currents supplied to the memory cell MC[p, q] and the memory cell MC[p+1, q] from the wiring BL[q] is the current I[q]. When the drain current flowing in the transistor Tr11 in the memory cell MC[p, q+1] is a current I[p, q+1] and the drain current flowing in the transistor Tr11 in the memory cell MC[p+1, q+1] is a current I[p+1, q+1], the sum of currents supplied to the memory cell MC[p, q+1] and the memory cell MC[p+1, q+1] from the wiring BL[q+1] is a current I[q+1]. When the drain current flowing in the transistor Tr11 in the memory cell MCR[p] is the current IREF[p] and the drain current flowing in the transistor Tr11 in the memory cell MCR[p+1] is the current IREF[p+1], the sum of currents supplied to the memory cell MCR[p] and the memory cell MCR[p+1] from the wiring BLREF is the current IREF.

### Configuration Examples of Circuit 530, Circuit 540, and Current Supply Circuit

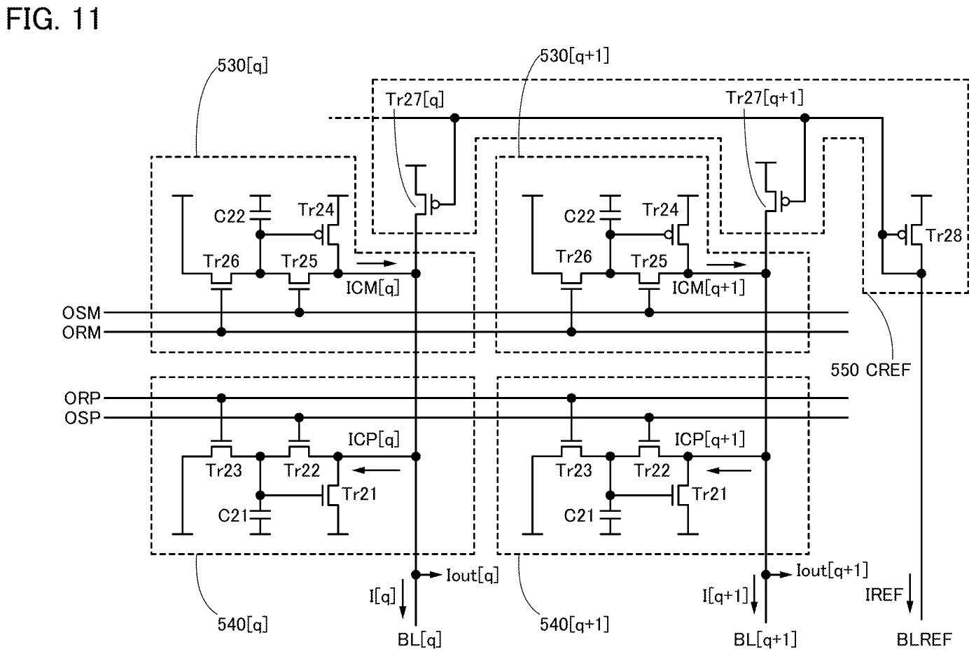

Next, specific configuration examples of the circuit 530, the circuit 540, and the current supply circuit 550 (CREF) will be described with reference to FIG. 11.

FIG. 11 illustrates a configuration example of the circuit 530, the circuit 540, and the current supply circuit 550 for the memory cells MC and the memory cells MCR illustrated in FIG. 10. Specifically, the circuit 530 illustrated in FIG. 11 includes a circuit 530[q] for the memory cells MC in the q-th column and a circuit 530[q+1] for the memory cells MC in the (q+1)-th column. Furthermore, the circuit 540 illustrated in FIG. 11 includes a circuit 540[q] for the memory cells MC in the q-th column and a circuit 540[q+1] for the memory cells MC in the (q+1)-th column.

The circuit 530[q] and the circuit 540[q] are connected to the wiring BL[q]. The circuit 530[q+1] and the circuit 540[q+1] are connected to the wiring BL[q+1].

The current supply circuit 550 is connected to the wiring BL[q], the wiring BL[q+1], and the wiring BLREF. The current supply circuit 550 has a function of supplying the current IREF to the wiring BLREF and a function of supplying a current that is the same as the current IREF or a current that corresponds to the current IREF to each of the wiring BL[q] and the wiring BL[q+1].

Specifically, the circuit 530[q] and the circuit 530[q+1] each include transistors Tr24 to Tr26 and a capacitor C22. The transistor Tr24 in the circuit 530[q] has a function of generating the current ICM[q] that corresponds to the difference between the current I[q] and the current IREF, when the current I[q] is higher than the current IREF and an offset current is set. Furthermore, the transistor Tr24 in the circuit 530[q+1] has a function of generating a current ICM[q+1] that corresponds to the difference between the current I[q+1] and the current IREF, when the current I[q+1] is higher than the current IREF. The current ICM[q] and the current ICM[q+1] are supplied from the circuit 530[q] and the circuit 530[q+1] to the wiring BL[q] and the wiring BL[q+1], respectively.

In each of the circuit 530[q] and the circuit 530[q+1], one of a source and a drain of the transistor Tr24 is connected to the corresponding wiring BL, and the other of the source and the drain is connected to a wiring through which a predetermined potential is supplied. One of a source and a drain of the transistor Tr25 is connected to the wiring BL, and the other of the source and the drain is connected to a gate of the transistor Tr24. One of a source and a drain of the transistor Tr26 is connected to the gate of the transistor Tr24, and the other of the source and the drain is connected to a wiring through which a predetermined potential is supplied. A first electrode of the capacitor C22 is connected to the gate of the transistor Tr24, and a second electrode is connected to a wiring through which a predetermined potential is supplied.

A gate of the transistor Tr25 is connected to a wiring OSM, and a gate of the transistor Tr26 is connected to a wiring ORM.

Note that FIG. 11 illustrates an example where the transistor Tr24 is a p-channel transistor and the transistors Tr25 and Tr26 are n-channel transistors.

The circuit 540[q] and the circuit 540[q+1] each include transistors Tr21 to Tr23 and a capacitor C21. The transistor Tr21 in the circuit 540[q] has a function of generating the current ICP[q] that corresponds to the difference between the current I[q] and the current IREF, when the current I[q] is lower than the current IREF and an offset current is set. Furthermore, the transistor Tr21 in the circuit 540[q+1] has a function of generating a current ICP[q+1] that corresponds to the difference between the current I[q+1] and the current IREF, when the current I[q+1] is lower than the current IREF. The current ICP[q] and the current ICP[q+1] are drawn from the wiring BL[q] and the wiring BL[q+1] into the circuit 540[q] and the circuit 540[q+1], respectively.

Note that the current ICM[q] and the current ICP[q] each correspond to the current Ioffset[q]. The current ICM[q+1] and the current ICP[q+1] each correspond to a current Ioffset[q+1].

In each of the circuit 540[q] and the circuit 540[q+1], one of a source and a drain of the transistor Tr21 is connected to the corresponding wiring BL, and the other of the source and the drain is connected to a wiring through which a predetermined potential is supplied. One of a source and a drain of the transistor Tr22 is connected to the wiring BL, and the other of the source and the drain is connected to a gate of the transistor Tr21. One of a source and a drain of the transistor Tr23 is connected to the gate of the transistor Tr21, and the other of the source and the drain is connected to a wiring through which a predetermined potential is supplied. A first electrode of the capacitor C21 is connected to the gate of the transistor Tr21, and a second electrode is connected to a wiring through which a predetermined potential is supplied.

A gate of the transistor Tr22 is connected to a wiring OSP, and a gate of the transistor Tr23 is connected to a wiring ORP.

Note that FIG. 11 illustrates an example where the transistors Tr21 to Tr23 are n-channel channel transistors.

The current supply circuit 550 includes a transistor Tr27 for the wiring BL and a transistor Tr28 for the wiring BLREF. Specifically, FIG. 11 illustrates an example where the current supply circuit 550 includes, as the transistor Tr27, a transistor Tr27[q] for the wiring BL[q] and a transistor Tr27[q+1] for the wiring BL[q+1].

A gate of the transistor Tr27 is connected to a gate of the transistor Tr28. One of a source and a drain of the transistor Tr27 is connected to the corresponding wiring BL, and the other of the source and the drain is connected to a wiring through which a predetermined potential is supplied. One of a source and a drain of the transistor Tr28 is connected to the wiring BLREF, and the other of the source and the drain is connected to a wiring through which a predetermined potential is supplied.

The transistor Tr27 and the transistor Tr28 have the same polarity. FIG. 11 illustrates an example where the transistor Tr27 and the transistor Tr28 are p-channel transistors.

The drain current of the transistor Tr28 corresponds to the current IREF. The transistor Tr27 and the transistor Tr28 collectively serve as a current mirror circuit; thus, the drain current of the transistor Tr27 is substantially the same as the drain current of the transistor Tr28 or corresponds to the drain current of the transistor Tr28.

### Operation Example of Semiconductor Device

Next, a specific operation example of the semiconductor device 500 of one embodiment of the present invention will be described with reference to FIG. 10 to FIG. 12.

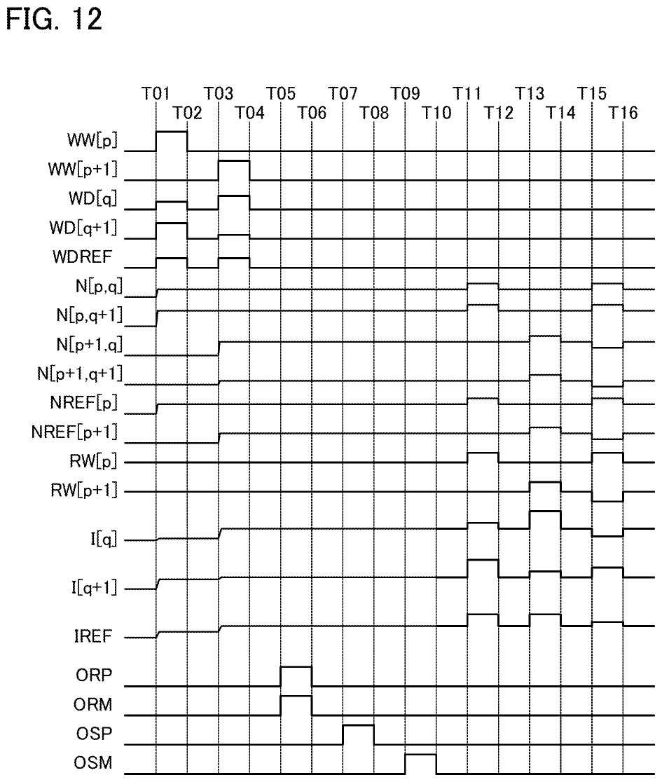

FIG. 12 corresponds to an example of a timing chart showing the operations of the memory cells MC and the memory cells MCR illustrated in FIG. 10 and the circuit 530, the circuit 540, and the current supply circuit 550 illustrated in FIG. 11. From Time T01 to Time T04 in FIG. 12, the first analog data is stored in the memory cells MC and the memory cells MCR. From Time T05 to Time T10, the offset current Ioffset flowing in the circuit 530 and the circuit 540 is set. From Time T11 to Time T16, data corresponding to the product-sum of the first analog data and the second analog data is obtained.

Note that a low-level potential is supplied to the wiring VR[q] and the wiring VR[q+1]. The high-level potential VDD is supplied to all wirings having a predetermined potential that are connected to the circuit 530. The low-level potential VSS is supplied to all wirings having a predetermined potential that are connected to the circuit 540. Furthermore, the high-level potential VDD is supplied to all wirings having a predetermined potential that are connected to the current supply circuit 550.

The transistors Tr11, Tr21, Tr24, Tr27[q], Tr27[q+1], and Tr28 each operate in a saturation region.

First, a high-level potential is applied to the wiring WW[p] and a low-level potential is applied to the wiring WW[p+1] from Time T01 to Time T02. As a result of the above operation, the transistors Tr12 in the memory cell MC[p, q], the memory cell MC[p, q+1], and the memory cell MCR[p] illustrated in FIG. 10 are turned on. The transistors Tr12 in the memory cell MC[p+1, q], the memory cell MC[p+1, q+1], and the memory cell MCR[p+1] remain off.

In addition, from Time T01 to Time T02, a potential obtained by subtracting the first analog potential from the first reference potential VPR is applied to each of the wiring WD[q] and the wiring WD[q+1] illustrated in FIG. 10. Specifically, the potential VPR−Vx[p, q] is applied to the wiring WD[q], and a potential VPR−Vx[p, q+1] is applied to the wiring WD[q+1]. The first reference potential VPR is applied to the wiring WDREF, and a potential between the potential VSS and the potential VDD, e.g., a potential (VDD+VSS)/2, is applied as a base potential to the wiring RW[p] and the wiring RW[p+1].

Accordingly, in FIG. 10, the potential VPR−Vx[p, q] is applied to a node N[p, q] through the transistor Tr12 in the memory cell MC[p, q], the potential VPR−Vx[p, q+1] is applied to a node N[p, q+1] through the transistor Tr12 in the memory cell MC[p, q+1], and the first reference potential VPR is applied to a node NREF[p] through the transistor Tr12 in the memory cell MCR[p].

After Time T02, the potential applied to the wiring WW[p] illustrated in FIG. 10 changes from a high level to a low level, so that the transistors Tr12 in the memory cell MC[p, q], the memory cell MC[p, q+1], and the memory cell MCR[p] are turned off. As a result of the above operation, the potential VPR−Vx[p, q] is held at the node N[p, q], the potential VPR−Vx[p, q+1] is held at the node N[p, q+1], and the first reference potential VPR is held at the node NREF[p].

Then, from Time T03 to Time T04, the potential of the wiring WW[p] illustrated in FIG. 10 remains at a low level and a high-level potential is applied to the wiring WW[p+1]. As a result of the above operation, the transistors Tr12 in the memory cell MC[p+1, q], the memory cell MC[p+1, q+1], and the memory cell MCR[p+1] illustrated in FIG. 10 are turned on. The transistors Tr12 in the memory cell MC[p, q], the memory cell MC[p, q+1], and the memory cell MCR[p] remain off.

In addition, from Time T03 to Time T04, a potential obtained by subtracting the first analog potential from the first reference potential VPR is applied to each of the wiring WD[q] and the wiring WD[q+1] illustrated in FIG. 10. Specifically, the potential VPR−Vx[p+1, q] is applied to the wiring WD[q], and a potential VPR−Vx[p+1, q+1] is applied to the wiring WD[q+1]. The first reference potential VPR is applied to the wiring WDREF, and a potential between the potential VSS and the potential VDD, e.g., the potential (VDD+VSS)/2, is applied as a base potential to the wiring RW[p] and the wiring RW[p+1].

Accordingly, in FIG. 10, the potential VPR−Vx[p+1, q] is applied to a node N[p+1, q] through the transistor Tr12 in the memory cell MC[p+1, q], the potential VPR−Vx[p+1, q+1] is applied to a node N[p+1, q+1] through the transistor Tr12 in the memory cell MC[p+1, q+1], and the first reference potential VPR is applied to a node NREF[p+1] through the transistor Tr12 in the memory cell MCR[p+1].

After Time T04, the potential applied to the wiring WW[p+1] illustrated in FIG. 10 changes from a high level to a low level, so that the transistors Tr12 in the memory cell MC[p+1, q], the memory cell MC[p+1, q+1], and the memory cell MCR[p+1] are turned off. As a result of the above operation, the potential VPR−Vx[p+1, q] is held at the node N[p+1, q], the potential VPR−Vx[p+1, q+1] is held at the node N[p+1, q+1], and the first reference potential VPR is held at the node NREF[p+1].

Next, a high-level potential is applied to the wiring ORP and the wiring ORM illustrated in FIG. 11 from Time T05 to Time T06. When a high-level potential is applied to the wiring ORM, the transistors Tr26 in the circuit 530[q] and the circuit 530[q+1] illustrated in FIG. 11 are turned on, so that the gates of the transistors Tr24 are reset by the potential VDD applied thereto. Furthermore, when a high-level potential is applied to the wiring ORP, the transistors Tr23 in the circuit 540[q] and the circuit 540[q+1] illustrated in FIG. 11 are turned on, so that the gates of the transistors Tr21 are reset by the potential VSS applied thereto.

After Time T06, the potential applied to the wiring ORP and the wiring ORM illustrated in FIG. 10 changes from a high level to a low level, so that the transistors Tr26 in the circuit 530[q] and the circuit 530[q+1] are turned off and the transistors Tr23 in the circuit 540[q] and the circuit 540[q+1] are turned off. As a result of the above operation, the potential VDD is held at the gate of the transistor Tr24 in each of the circuit 530[q] and the circuit 530[q+1], and the potential VSS is held at the gate of the transistor Tr21 in each of the circuit 540[q] and the circuit 540[q+1].

Next, from Time T07 to Time T08, a high-level potential is applied to the wiring OSP illustrated in FIG. 11. Furthermore, a potential between the potential VSS and the potential VDD, e.g., the potential (VDD+VSS)/2, is applied as a base potential to the wiring RW[p] and the wiring RW[p+1] illustrated in FIG. 10. Since a high-level potential is applied to the wiring OSP, the transistors Tr22 in the circuit 540[q] and the circuit 540[q+1] are turned on.

If the current I[q] flowing through the wiring BL[q] is lower than the current IREF flowing through the wiring BLREF, that is, if the current ΔI[q] has a positive value, it means that the sum of a current that can be drawn by the transistor Tr11 in the memory cell MC[p, q] illustrated in FIG. 10 and a current that can be drawn by the transistor Tr11 in the memory cell MC[p+1, q] is smaller than the drain current of the transistor Tr27[q]. Thus, if the current ΔI[q] has a positive value, part of the drain current of the transistor Tr27[q] flows to the gate of the transistor Tr21 when the transistor Tr22 is turned on in the circuit 540[q], and the potential of the gate starts to increase. When the drain current of the transistor Tr21 becomes substantially equal to the current ΔI[q], the potential of the gate of the transistor Tr21 converges on a certain value. The potential of the gate of the transistor Tr21 at this time corresponds to a potential at which the drain current of the transistor Tr21 becomes the current ΔI[q], i.e., the current Ioffset[q] (=ICP[q]). This means that the transistor Tr21 in the circuit 540[q] is in a state of serving as a current source that can supply the current ICP[q].

Similarly, if the current I[q+1] flowing through the wiring BL[q+1] is lower than the current IREF flowing through the wiring BLREF, that is, if a current ΔI[q+1] has a positive value, part of the drain current of the transistor Tr27[q+1] flows to the gate of the transistor Tr21 when the transistor Tr22 in the circuit 540[q+1] is turned on, and the potential of the gate starts to increase. When the drain current of the transistor Tr21 becomes substantially equal to the current ΔI[q+1], the potential of the gate of the transistor Tr21 converges on a certain value. The potential of the gate of the transistor Tr21 at this time corresponds to a potential at which the drain current of the transistor Tr21 becomes the current ΔI[q+1], i.e., the current Ioffset[q+1] (=ICP[q+1]). This means that the transistor Tr21 in the circuit 540[q+1] is in a state of serving as a current source that can supply the current ICP[q+1].

After Time T08, the potential applied to the wiring OSP illustrated in FIG. 11 changes from a high level to a low level, so that the transistors Tr22 in the circuit 540[q] and the circuit 540[q+1] are turned off. As a result of the above operation, the potentials of the gates of the transistors Tr21 are held. Thus, the circuit 540[q] remains in a state of serving as the current source that can supply the current ICP[q], and the circuit 540[q+1] remains in a state of serving as the current source that can supply the current ICP[q+1].

Next, from Time T09 to Time T10, a high-level potential is applied to the wiring OSM illustrated in FIG. 11. Furthermore, a potential between the potential VSS and the potential VDD, e.g., the potential (VDD+VSS)/2, is applied as a base potential to the wiring RW[p] and the wiring RW[p+1] illustrated in FIG. 10. Since a high-level potential is applied to the wiring OSM, the transistors Tr25 in the circuit 530[q] and the circuit 530[q+1] are turned on.

If the current I[q] flowing through the wiring BL[q] is higher than the current IREF flowing through the wiring BLREF, that is, if the current ΔI[q] has a negative value, it means that the sum of a current that can be drawn by the transistor Tr11 in the memory cell MC[p, q] illustrated in FIG. 10 and a current that can be drawn by the transistor Tr11 in the memory cell MC[p+1, q] is larger than the drain current of the transistor Tr27[q]. Thus, if the current ΔI[q] has a negative value, a current flows from the gate of the transistor Tr24 to the wiring BL[q] when the transistor Tr25 in the circuit 530[q] is turned on, and the potential of the gate starts to decrease. When the drain current of the transistor Tr24 becomes substantially equal to the current ΔI[q], the potential of the gate of the transistor Tr24 converges on a certain value. The potential of the gate of the transistor Tr24 at this time corresponds to a potential at which the drain current of the transistor Tr24 becomes the current ΔI[q], i.e., the current Ioffset[q] (=ICM[q]). This means that the transistor Tr24 in the circuit 530[q] is in a state of serving as a current source that can supply the current ICM[q].

Similarly, if the current I[q+1] flowing through the wiring BL[q+1] is higher than the current IREF flowing through the wiring BLREF, that is, if the current ΔI[q+1] has a negative value, a current flows from the gate of the transistor Tr24 in the circuit 530[q+1] to the wiring BL[q+1] when the transistor Tr25 is turned on, and the potential of the gate starts to decrease. When the drain current of the transistor Tr24 becomes substantially equal to the absolute value of the current ΔI[q+1], the potential of the gate of the transistor Tr24 converges on a certain value. The potential of the gate of the transistor Tr24 at this time corresponds to a potential at which the drain current of the transistor Tr24 is equal to the absolute value of the current ΔI[q+1], i.e., the current Ioffset[q+1] (=ICM[q+1]). This means that the transistor Tr24 in the circuit 530[q+1] is in a state of serving as a current source that can supply the current ICM[q+1].

After Time T10, the potential applied to the wiring OSM illustrated in FIG. 11 changes from a high level to a low level, so that the transistors Tr25 in the circuit 530[q] and the circuit 530[q+1] are turned off. As a result of the above operation, the potentials of the gates of the transistors Tr24 are held. Thus, the circuit 530[q] remains in a state of serving as the current source that can supply the current ICM[q], and the circuit 530[q+1] remains in a state of serving as the current source that can supply the current ICM[q+1].

In each of the circuit 540[q] and the circuit 540[q+1], the transistor Tr21 has a function of drawing current. Thus, from Time T07 to Time T08, when the current I[q] flowing through the wiring BL[q] is higher than the current IREF flowing through the wiring BLREF and the current ΔI[q] has a negative value, or when the current I[q+1] flowing through the wiring BL[q+1] is higher than the current IREF flowing through the wiring BLREF and the current ΔI[q+1] has a negative value, it might be difficult to supply current from the circuit 540[q] or the circuit 540[q+1] to the wiring BL[q] or the wiring BL[q+1] without excess or deficiency. In that case, it might be difficult for the transistor Tr11 in the memory cell MC, the transistor Tr21 in the circuit 540[q] or the circuit 540[q+1], and the transistor Tr27[q] or Tr27[q+1] to concurrently operate in a saturation region because a balance between the current flowing through the wiring BLREF and the current flowing through the wiring BL[q] or the wiring BL[q+1] is struck.

To ensure the operations of the transistors Tr11, Tr21, and Tr27[q] or Tr27[q+1] in a saturation region from Time T07 to Time T08 even when the current ΔI[q] has a negative value, the potential of the gate of the transistor Tr24 may be set to a potential that is high enough to obtain a predetermined drain current, instead of being resetting the potential of the gate of the transistor Tr24 to the potential VDD, from Time T05 to Time T06. In the above structure, the amount of current that cannot be drawn by the transistor Tr11 can be drawn by the transistor Tr21 to some extent because a current from the transistor Tr24, as well as the drain current of the transistor Tr27[q] or Tr27[q+1], is supplied; thus, the operations of the transistors Tr11, Tr21, and Tr27[q] or Tr27[q+1] in a saturation region can be ensured.

Note that if the current I[q] flowing through the wiring BL[q] is lower than the current IREF flowing through the wiring BLREF, that is, if the ΔI[q] has a positive value, from Time T09 to Time T10, since the circuit 540[q] has been set as the current source that can supply the current ICP[q] from Time T07 to Time T08, the potential of the gate of the transistor Tr24 in the circuit 530[q] remains substantially the same as the potential VDD. Similarly, if the current I[q+1] flowing through the wiring BL[q+1] is lower than the current IREF flowing through the wiring BLREF, that is, if the current ΔI[q+1] has a positive value, since the circuit 540[q+1] has been set as the current source that can supply the current ICP[q+1] from Time T07 to Time T08, the potential of the gate of the transistor Tr24 in the circuit 530[q+1] remains substantially the same as the potential VDD.

Then, from Time T11 to Time T12, the second analog potential Vw[p] is applied to the wiring RW[p] illustrated in FIG. 10. A potential between the potential VSS and the potential VDD, e.g., the potential (VDD+VSS)/2, is still applied as a base potential to the wiring RW[p+1]. Specifically, the potential of the wiring RW[p] is a potential higher than the potential between the potential VSS and the potential VDD (e.g., the potential (VDD+VSS)/2), which is a base potential, by the potential difference Vw[p]; for the simplicity of the following description, however, the potential of the wiring RW[p] is assumed to be the second analog potential Vw[p].

When the wiring RW[p] becomes the second analog potential Vw[p], with the assumption that the amount of change in the potential of the first electrode of the capacitor C11 is substantially the same as the amount of change in the potential of the node N, the potential of the node N[p, q] in the memory cell MC[p, q] illustrated in FIG. 10 becomes VPR−Vx[p, q]+Vw[p] and the potential of the node N[p, q+1] in the memory cell MC[p, q+1] becomes VPR−Vx[p, q+1]+Vw[p]. According to Formula 6 above, the product-sum of the first analog data and the second analog data for the memory cell MC[p, q] affects a current obtained by subtracting the current Ioffset[q] from the current ΔI[q], that is, the current Iout[q] flowing from the wiring BL[q]. Furthermore, the product-sum of the first analog data and the second analog data for the memory cell MC[p, q+1] affects a current obtained by subtracting the current Ioffset[q+1] from the current ΔI[q+1], that is, a current Iout[q+1] flowing from the wiring BL[q+1].

After Time T12, a potential between the potential VSS and the potential VDD (e.g., the potential (VDD+VSS)/2), which is a base potential, is applied again to the wiring RW[p].

Then, from Time T13 to Time T14, the second analog potential Vw[p+1] is applied to the wiring RW[p+1] illustrated in FIG. 10. Furthermore, a potential between the potential VSS and the potential VDD, e.g., the potential (VDD+VSS)/2, is still applied as a base potential to the wiring RW[p]. Specifically, the potential of the wiring RW[p+1] is a potential higher than the potential between the potential VSS and the potential VDD (e.g., the potential (VDD+VSS)/2), which is a base potential, by the potential difference Vw[p+1]; for the simplicity of the following description, however, the potential of the wiring RW[p+1] is assumed to be the second analog potential Vw[p+1].

When the wiring RW[p+1] becomes the second analog potential Vw[p+1], with the assumption that the amount of change in the potential of the first electrode of the capacitor C11 is substantially the same as the amount of change in the potential of the node N, the potential of the node N[p+1, q] in the memory cell MC[p+1, q] illustrated in FIG. 10 becomes VPR−Vx[p+1, q]+Vw[p+1] and the potential of the node N[p+1, q+1] in the memory cell MC[p+1, q+1] becomes VPR−Vx[p+1, q+1]+Vw[p+1]. According to Formula 6 above, the product-sum of the first analog data and the second analog data for the memory cell MC[p+1, q] affects a current obtained by subtracting the current Ioffset[q] from the current ΔI[q], that is, the current Iout[q]. Furthermore, the product-sum of the first analog data and the second analog data for the memory cell MC[p+1, q+1] affects a current obtained by subtracting the current Ioffset[q+1] from the current ΔI[q+1], that is, the current Iout[q+1].

After Time T14, a potential between the potential VSS and the potential VDD (e.g., the potential (VDD+VSS)/2), which is a base potential, is applied again to the wiring RW[p+1].

Then, from Time T15 to Time T16, the second analog potential Vw[p] is applied to the wiring RW[p] illustrated in FIG. 10 and the second analog potential Vw[p+1] is applied to the wiring RW[p+1]. Specifically, the potential of the wiring RW[p] is a potential higher than the potential between the potential VSS and the potential VDD (e.g., the potential (VDD+VSS)/2), which is a base potential, by the potential difference Vw[p], and the potential of the wiring RW[p+1] is a potential higher than the potential between the potential VSS and the potential VDD (e.g., the potential (VDD+VSS)/2), which is a base potential, by the potential difference Vw[p+1]; for the simplicity of the following description, however, the potential of the wiring RW[p] is assumed to be the second analog potential Vw[p] and the potential of the wiring RW[p+1] is assumed to be the second analog potential Vw[p+1].

When the wiring RW[p] becomes the second analog potential Vw[p], with the assumption that the amount of change in the potential of the first electrode of the capacitor C11 is substantially the same as the amount of change in the potential of the node N, the potential of the node N[p, q] in the memory cell MC[p, q] illustrated in FIG. 10 becomes VPR−Vx[p, q]+Vw[p] and the potential of the node N[p, q+1] in the memory cell MC[p, q+1] becomes VPR−Vx[p, q+1]+Vw[p]. Furthermore, when the wiring RW[p+1] becomes the second analog potential Vw[p+1], with the assumption that the amount of change in the potential of the first electrode of the capacitor C11 is substantially the same as the amount of change in the potential of the node N, the potential of the node N[p+1, q] in the memory cell MC[p+1, q] illustrated in FIG. 10 becomes VPR−Vx[p+1, q]+Vw[p+1] and the potential of the node N[p+1, q+1] in the memory cell MC[p+1, q+1] becomes VPR−Vx[p+1, q+1]+Vw[p+1].

According to Formula 6 above, the product-sum of the first analog data and the second analog data for the memory cell MC[p, q] and the memory cell MC[p+1, q] affects a current obtained by subtracting the current Ioffset[q] from the current ΔI[q], that is, the current Iout[q]. Furthermore, the product-sum of the first analog data and the second analog data for the memory cell MC[p, q+1] and the memory cell MC[p+1, q+1] affects a current obtained by subtracting the current Ioffset[q+1] from the current ΔI[q+1], that is, the current Iout[q+1].

After Time T16, a potential between the potential VSS and the potential VDD (e.g., the potential (VDD+VSS)/2), which is a base potential, is applied again to the wiring RW[p] and the wiring RW[p+1].

With the above structure, the product-sum operation can be performed with a small circuit scale. With the above structure, the product-sum operation can be performed at high speed. With the above structure, the product-sum operation can be performed with low power.

Note that a transistor with an extremely low off-state current is desirably used as the transistor Tr12, Tr22, Tr23, Tr25, or Tr26. When a transistor with an extremely low off-state current is used as the transistor Tr12, the potential of the node N can be held for a long time. When a transistor with an extremely low off-state current is used as the transistors Tr22 and Tr23, the potential of the gate of the transistor Tr21 can be held for a long time. When a transistor with an extremely low off-state current is used as the transistors Tr25 and Tr26, the potential of the gate of the transistor Tr24 can be held for a long time.

As a transistor with an extremely low off-state current, an OS transistor may be used. The off-state current of an OS transistor normalized by channel width can be lower than or equal to 10×10⁻²¹ A/μm (10 zA/μm) with a source-drain voltage of 10 V at room temperature (approximately 25° C.).

With the use of the semiconductor device described above, the product-sum operation in the neural network NN can be performed.

This embodiment can be combined with the description of the other embodiments as appropriate.

### Embodiment 4

In this embodiment, a structure example of an OS transistor that can be used in the above embodiment will be described.

### Structure Example of Transistor

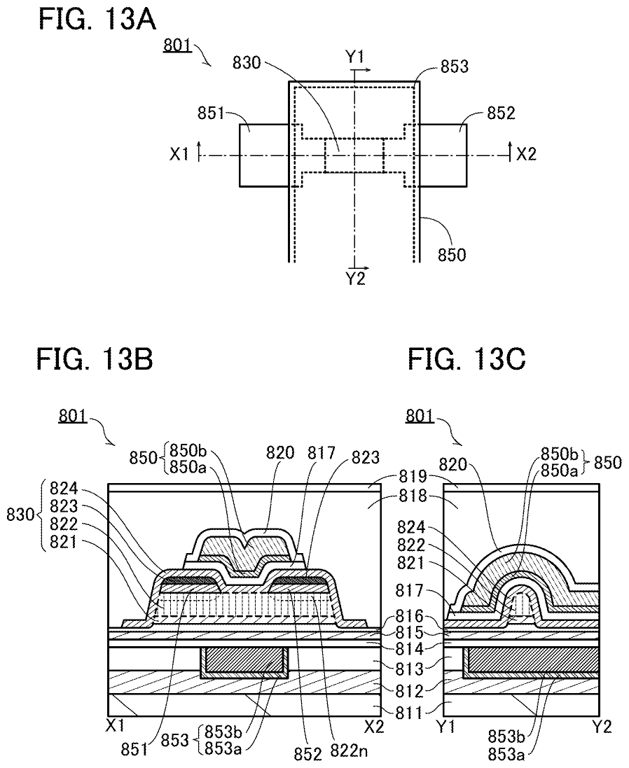

FIG. 13(A) is a top view illustrating a structure example of a transistor. FIG. 13(B) is a cross-sectional view along the line X1-X2 in FIG. 13(A), and FIG. 13(C) is a cross-sectional view along the line Y1-Y2. Here, in some cases, the direction of the line X1-X2 is referred to as a channel length direction and the direction of the line Y1-Y2 as a channel width direction. FIG. 13(B) is a diagram illustrating a cross-sectional structure of the transistor in the channel length direction, and FIG. 13(C) is a diagram illustrating a cross-sectional structure of the transistor in the channel width direction. Note that to clarify the device structure, some components are omitted in FIG. 13(A).

The semiconductor device of one embodiment of the present invention includes insulating layers 812 to 820, metal oxide films 821 to 824, and conductive layers 850 to 853. A transistor 801 is formed on an insulating surface. FIG. 13 illustrates the case where the transistor 801 is formed over an insulating layer 811. The transistor 801 is covered with the insulating layer 818 and the insulating layer 819.

Note that the insulating layers, the metal oxide films, the conductive layers, and the like that constitute the transistor 801 may be a single layer or may be a stack including a plurality of films. They can be formed by a variety of deposition methods such as a sputtering method, a molecular beam epitaxy method (MBE method), a pulsed laser ablation method (PLA method), a CVD method, and an atomic layer deposition method (ALD method). Note that examples of a CVD method include a plasma CVD method, a thermal CVD method, and a metal organic CVD method.

The conductive layer 850 includes a region that functions as a gate electrode of the transistor 801. The conductive layer 850 may include a stack of a conductive layer 850a and a conductive layer 850b that are made with different materials. The conductive layer 851 and the conductive layer 852 include regions that function as a source electrode and a drain electrode. The conductive layer 853 includes a region that functions as a back gate electrode. The conductive layer 853 may include a stack of a conductive layer 853a and a conductive layer 853b that are made with different materials. The insulating layer 817 includes a region that functions as a gate insulating layer on the gate electrode (front gate electrode) side, and an insulating layer formed of a stack of the insulating layer 814 to the insulating layer 816 includes a region that functions as a gate insulating layer on the back gate electrode side. The insulating layer 818 functions as an interlayer insulating layer. The insulating layer 819 functions as a barrier layer.

The metal oxide films 821 to 824 are collectively referred to as an oxide layer 830. As illustrated in FIG. 13(B) and FIG. 13(C), the oxide layer 830 includes a region where the metal oxide film 821, the metal oxide film 822, and the metal oxide film 824 are stacked in this order. In addition, a pair of metal oxide films 823 are positioned over the conductive layer 851 and the conductive layer 852. When the transistor 801 is on, a channel formation region is mainly formed in the metal oxide film 822 of the oxide layer 830.

The metal oxide film 824 covers the metal oxide films 821 to 823, the conductive layer 851, and the conductive layer 852. The insulating layer 817 is positioned between the metal oxide film 823 and the conductive layer 850. The conductive layer 851 and the conductive layer 852 each include a region that overlaps with the conductive layer 850 with the metal oxide film 823, the metal oxide film 824, and the insulating layer 817 therebetween.

The conductive layer 851 and the conductive layer 852 are formed from a hard mask for forming the metal oxide film 821 and the metal oxide film 822. Thus, the conductive layer 851 and the conductive layer 852 do not include a region that is in contact with the side surfaces of the metal oxide film 821 and the metal oxide film 822. For example, the metal oxide films 821 and 822, the conductive layer 851, and the conductive layer 852 can be formed through the following steps. First, a conductive film is formed over two stacked metal oxide films. This conductive film is processed (etched) into a desired shape so that a hard mask is formed. With the use of the hard mask, the shapes of the two metal oxide films are processed so that the metal oxide film 821 and the metal oxide film 822 that are stacked are formed. Next, the hard mask is processed into a desired shape so that the conductive layer 851 and the conductive layer 852 are formed.

Examples of insulating materials used for the insulating layers 811 to 818 include aluminum nitride, aluminum oxide, aluminum nitride oxide, aluminum oxynitride, magnesium oxide, silicon nitride, silicon oxide, silicon nitride oxide, silicon oxynitride, gallium oxide, germanium oxide, yttrium oxide, zirconium oxide, lanthanum oxide, neodymium oxide, hafnium oxide, tantalum oxide, and aluminum silicate. The insulating layers 811 to 818 are formed of a single layer or a stack containing these insulating materials. The layers forming the insulating layers 811 to 818 may contain a plurality of insulating materials.

Note that in this specification and the like, oxynitride refers to a compound in which the oxygen content is higher than the nitrogen content, and nitride oxide refers to a compound in which the nitrogen content is higher than the oxygen content.

In order to suppress an increase in oxygen vacancies in the oxide layer 830, the insulating layer 816 to the insulating layer 818 are preferably insulating layers containing oxygen. Further preferably, the insulating layer 816 to the insulating layer 818 are formed of an insulating film from which oxygen is released by heating (hereinafter, also referred to as an “insulating film containing excess oxygen”). Supplying oxygen from the insulating film containing excess oxygen to the oxide layer 830 can compensate for the oxygen vacancies in the oxide layer 830. As a result, the reliability and electrical characteristics of the transistor 801 can be improved.

The insulating layer containing excess oxygen is a film from which oxygen molecules at more than or equal to 1.0×10¹⁸ molecules/cm³ are released in TDS (Thermal Desorption Spectroscopy) at a film surface temperature of higher than or equal to 100° C. and lower than or equal to 700° C., or higher than or equal to 100° C. and lower than or equal to 500° C. The number of released oxygen molecules is preferably 3.0×10²⁰ molecules/cm³ or more.

The insulating film containing excess oxygen can be formed by performing treatment for adding oxygen to an insulating film. The treatment for adding oxygen can be performed by heat treatment under an oxygen atmosphere, an ion implantation method, an ion doping method, a plasma immersion ion implantation method, plasma treatment, or the like. As a gas for adding oxygen, an oxygen gas of ¹⁶O₂, ¹⁸O₂, or the like, a nitrous oxide gas, an ozone gas, or the like can be used.

The hydrogen concentrations of the insulating layers 812 to 819 are preferably reduced in order to prevent an increase in hydrogen concentration of the oxide layer 830. In particular, the hydrogen concentrations of the insulating layers 813 to 818 are preferably reduced. Specifically, the hydrogen concentrations are lower than or equal to 2×10²⁰ atoms/cm³, preferably lower than or equal to 5×10¹⁹ atoms/cm³, further preferably lower than or equal to 1×10¹⁹ atoms/cm³, and still further preferably lower than or equal to 5×10¹⁸ atoms/cm³.

The above-mentioned hydrogen concentrations are values measured by secondary ion mass spectrometry (SIMS).

The transistor 801 preferably has a structure in which the oxide layer 830 is surrounded by an insulating layer with oxygen and hydrogen barrier properties (hereinafter, also referred to as a barrier layer). Employing such a structure can prevent release of oxygen from the oxide layer 830 and entry of hydrogen into the oxide layer 830. As a result, the reliability and electrical characteristics of the transistor 801 can be improved.

For example, the insulating layer 819 functions as a barrier layer and at least one of the insulating layers 811, 812, and 814 functions as a barrier layer. The barrier layer can be formed of a material such as aluminum oxide, aluminum oxynitride, gallium oxide, gallium oxynitride, yttrium oxide, yttrium oxynitride, hafnium oxide, hafnium oxynitride, or silicon nitride.

A structure example of the insulating layers 811 to 819 is described. In this example, each of the insulating layers 811, 812, 815, and 819 functions as a barrier layer. The insulating layers 816 to 818 are oxide layers containing excess oxygen. The insulating layer 811 is silicon nitride, the insulating layer 812 is aluminum oxide, and the insulating layer 813 is silicon oxynitride. The insulating layers 814 to 816 that function as the gate insulating layer on the back gate electrode side are a stack of silicon oxide, aluminum oxide, and silicon oxide. The insulating layer 817 that functions as the gate insulating layer on the front gate side is silicon oxynitride. The insulating layer 818 that functions as the interlayer insulating layer is silicon oxide. The insulating layer 819 is aluminum oxide.

Examples of conductive materials used for the conductive layers 850 to 853 include a metal such as molybdenum, titanium, tantalum, tungsten, aluminum, copper, chromium, neodymium, and scandium; and a metal nitride containing the above metal as its component (tantalum nitride, titanium nitride, molybdenum nitride, and tungsten nitride). It is possible to use a conductive material such as indium tin oxide, indium oxide containing tungsten oxide, indium zinc oxide containing tungsten oxide, indium oxide containing titanium oxide, indium tin oxide containing titanium oxide, indium zinc oxide, or indium tin oxide to which silicon oxide is added.

A structure example of the conductive layers 850 to 853 is described. The conductive layer 850 is a single layer of tantalum nitride or tungsten. Alternatively, the conductive layer 850 is a stack of tantalum nitride, tantalum, and tantalum nitride. The conductive layer 851 is a single layer of tantalum nitride or a stack of tantalum nitride and tungsten. The structure of the conductive layer 852 is the same as that of the conductive layer 851. The conductive layer 853 is a single layer of tantalum nitride or a stack of tantalum nitride and tungsten

In order to reduce the off-state current of the transistor 801, the energy gap of the metal oxide film 822 is preferably large, for example. The energy gap of the metal oxide film 822 is greater than or equal to 2.5 eV and less than or equal to 4.2 eV, preferably greater than or equal to 2.8 eV and less than or equal to 3.8 eV, further preferably greater than or equal to 3 eV and less than or equal to 3.5 eV.

The oxide layer 830 preferably exhibits crystallinity. At least the metal oxide film 822 preferably exhibits crystallinity. With the above-described structure, the transistor 801 having favorable reliability and electrical characteristics can be achieved.

Examples of the oxide that can be used for the metal oxide film 822 include an In—Ga oxide, an In—Zn oxide, and an In-M-Zn oxide (M is Al, Ga, Y, or Sn). The metal oxide film 822 is not limited to an oxide layer containing indium. The metal oxide film 822 can be formed using a Zn—Sn oxide, a Ga—Sn oxide, or a Zn—Mg oxide, for example. The metal oxide films 821, 823, and 824 can also be formed using an oxide that is similar to that used for the metal oxide film 822. In particular, each of the metal oxide films 821, 823, and 824 can be formed using a Ga oxide.

When an interface state is formed at the interface between the metal oxide film 822 and the metal oxide film 821, a channel formation region is formed also in a region in the vicinity of the interface, which causes a change in threshold voltage of the transistor 801. It is therefore preferred that the metal oxide film 821 contain at least one of the metal elements contained in the metal oxide film 822 as its component. Accordingly, an interface state is less likely to be formed at the interface between the metal oxide film 822 and the metal oxide film 821, and variations in electrical characteristics such as threshold voltage of the transistor 801 can be reduced.

The metal oxide film 824 preferably contains at least one of the metal elements contained in the metal oxide film 822 as its component. Thus, interface scattering is less likely to occur at the interface between the metal oxide film 822 and the metal oxide film 824, and carrier transfer is less likely to be inhibited; hence, the field-effect mobility of the transistor 801 can be increased.

It is preferred that the metal oxide film 822 have the highest carrier mobility among the metal oxide films 821 to 824. Accordingly, a channel can be formed in the metal oxide film 822 that is provided in a position apart from the insulating layers 816 and 817.

For example, in a metal oxide containing In, such as an In-M-Zn oxide, carrier mobility can be increased by an increase in the In content. An oxide having a high indium content has higher mobility than an oxide having a low indium content. Consequently, with the use of an oxide having a high indium content for the metal oxide film, carrier mobility can be increased.

For this reason, for example, the metal oxide film 822 is formed using an In—Ga—Zn oxide, and the metal oxide films 821 and 823 are formed using a Ga oxide. For example, when the metal oxide films 821 to 823 are formed using an In-M-Zn oxide, the In content of the metal oxide film 822 is made higher than the In content of the metal oxide films 821 and 823. When the In-M-Zn oxide is formed by a sputtering method, the In content can be changed by changing the atomic ratio of the metal elements of a target.

For example, the atomic ratio In:M:Zn of the metal elements of a target used for forming the metal oxide film 822 is preferably 1:1:1, 3:1:2, or 4:2:4.1. For example, the atomic ratio In:M:Zn of the metal elements of a target used for forming the metal oxide films 821 and 823 is preferably 1:3:2 or 1:3:4. The atomic ratio of an In-M-Zn oxide formed using a target of In:M:Zn=4:2:4.1 is approximately In: M Zn=4:2:3.

In order to provide the transistor 801 with stable electrical characteristics, it is preferable to reduce the concentration of impurities in the oxide layer 830. In the metal oxide, hydrogen, nitrogen, carbon, silicon, and a metal element other than its main component are impurities. For example, hydrogen and nitrogen contribute to formation of donor states, thereby increasing the carrier density. In addition, silicon and carbon contribute to formation of impurity states in the metal oxide. The impurity states serve as traps and might cause the electrical characteristics of the transistor to deteriorate.

For example, the oxide layer 830 includes a region where the silicon concentration is lower than or equal to 2×10¹⁸ atoms/cm³, preferably lower than or equal to 2×10¹⁷ atoms/cm³. The same applies to the carbon concentration of the oxide layer 830.

The oxide layer 830 includes a region where the concentration of an alkali metal is lower than or equal to 1×10¹⁸ atoms/cm³, preferably lower than or equal to 2×10¹⁶ atoms/cm³. The same applies to the concentration of an alkaline earth metal in the oxide layer 830.

The oxide layer 830 includes a region where the hydrogen concentration is lower than 1×10²⁰ atoms/cm³, preferably lower than 1×10¹⁹ atoms/cm³, further preferably lower than 5×10¹⁸ atoms/cm³, and still further preferably lower than 1×10¹⁸ atoms/cm³.

The above-mentioned concentrations of the impurities in the oxide layer 830 are values obtained by SIMS.

In the case where the metal oxide film 822 contains oxygen vacancies, donor states are sometimes formed by entry of hydrogen into sites of oxygen vacancies. As a result, the oxygen vacancies become a factor in decreasing the on-state current of the transistor 801. Note that sites of oxygen vacancies become more stable by entry of oxygen than by entry of hydrogen. Thus, by reducing oxygen vacancies in the metal oxide film 822, the on-state current of the transistor 801 can be increased in some cases. Consequently, preventing entry of hydrogen into sites of oxygen vacancies by reducing hydrogen in the metal oxide film 822 is effective for on-state current characteristics.

Hydrogen contained in a metal oxide reacts with oxygen bonded to a metal atom to be water, and thus forms an oxygen vacancy in some cases. Entry of hydrogen into the oxygen vacancy sometimes generates an electron serving as a carrier. Furthermore, in some cases, bonding of part of hydrogen to oxygen bonded to a metal atom generates an electron serving as a carrier. Since the channel formation region is provided in the metal oxide film 822, when hydrogen is contained in the metal oxide film 822, the transistor 801 is likely to have normally-on characteristics. Accordingly, it is preferred that hydrogen in the metal oxide film 822 be reduced as much as possible.

Note that the metal oxide film 822 may have an n-type region 822n in a region in contact with the conductive layer 851 or the conductive layer 852. The region 822n is formed by a phenomenon in which oxygen in the metal oxide film 822 is extracted by the conductive layer 851 or the conductive layer 852, a phenomenon in which a conductive material in the conductive layer 851 or the conductive layer 852 is combined with an element in the metal oxide film 822, or the like. When the region 822n is formed, the contact resistance between the conductive layer 851 or the conductive layer 852 and the metal oxide film 822 can be reduced.

FIG. 13 illustrates an example where the oxide layer 830 has a four-layer structure; however, one embodiment of the present invention is not limited to this. For example, the oxide layer 830 can have a three-layer structure without the metal oxide film 821 or the metal oxide film 823. Alternatively, one or a plurality of metal oxide films that are similar to the metal oxide films 821 to 824 can be provided at any two or more of the following positions: between given layers in the oxide layer 830, over the oxide layer 830, and under the oxide layer 830.

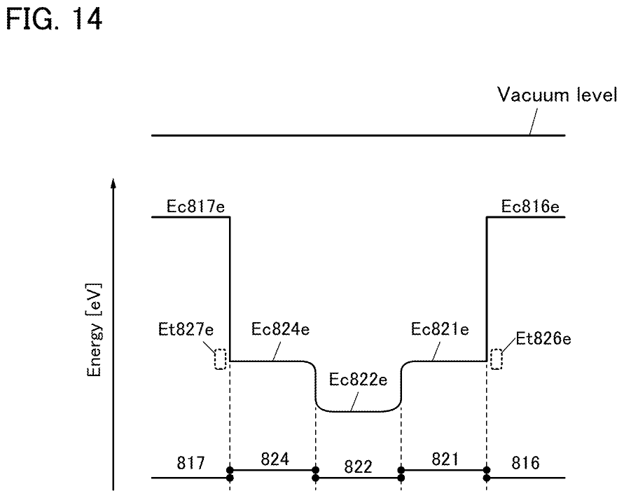

Effects obtained from the stack of the metal oxide films 821, 822, and 824 are described with reference to FIG. 14. FIG. 14 is a schematic diagram of the energy band structure of the channel formation region in the transistor 801.

In FIG. 14, Ec816e, Ec821e, Ec822e, Ec824e, and Ec817e indicate the energy of the conduction band minimums of the insulating layer 816, the metal oxide film 821, the metal oxide film 822, the metal oxide film 824, and the insulating layer 817, respectively.

Here, the energy difference between the vacuum level and the conduction band minimum (also referred to as “electron affinity”) is a value obtained by subtracting an energy gap from the energy difference between the vacuum level and the valence band maximum (also referred to as an ionization potential). Note that the energy gap can be measured using a spectroscopic ellipsometer (UT-300, HORIBA JOBIN YVON S.A.S.). Moreover, the energy difference between the vacuum level and the valence band maximum can be measured using an ultraviolet photoelectron spectroscopy (UPS) device (VersaProbe, ULVAC-PHI, Inc.).

Since the insulating layers 816 and 817 are insulators, Ec816e and Ec817e are closer to the vacuum level than Ec821e, Ec822e, and Ec824e (the insulating layers 816 and 817 have low electron affinities).

The metal oxide film 822 has a higher electron affinity than the metal oxide films 821 and 824. For example, the difference in electron affinity between the metal oxide film 822 and the metal oxide film 821 and the difference in electron affinity between the metal oxide film 822 and the metal oxide film 824 are each greater than or equal to 0.07 eV and less than or equal to 1.3 eV. The differences in electron affinity are preferably greater than or equal to 0.1 eV and less than or equal to 0.7 eV, further preferably greater than or equal to 0.15 eV and less than or equal to 0.4 eV. Note that the electron affinity is an energy difference between the vacuum level and the conduction band minimum.

When voltage is applied to the gate electrode (the conductive layer 850) of the transistor 801, a channel is mainly formed in the metal oxide film 822 having the highest electron affinity among the metal oxide film 821, the metal oxide film 822, and the metal oxide film 824.

An indium gallium oxide has a low electron affinity and a high oxygen-blocking property. Therefore, the metal oxide film 824 preferably contains an indium gallium oxide. The gallium atomic ratio [Ga/(In+Ga)] is, for example, higher than or equal to 70%, preferably higher than or equal to 80%, and further preferably higher than or equal to 90%.

A mixed region of the metal oxide film 821 and the metal oxide film 822 sometimes exists between the metal oxide film 821 and the metal oxide film 822. Moreover, a mixed region of the metal oxide film 824 and the metal oxide film 822 sometimes exists between the metal oxide film 824 and the metal oxide film 822. Because the mixed regions have a lower interface state density, a region in which the metal oxide films 821, 822, and 824 are stacked has a band structure where the energy in the vicinity of each interface is changed continuously (also referred to as continuous junction).

Electrons transfer mainly through the metal oxide film 822 in the oxide layer 830 having such an energy band structure. Thus, even when a state exists at the interface between the metal oxide film 821 and the insulating layer 816 or at the interface between the metal oxide film 824 and the insulating layer 817, electron transfer in the oxide layer 830 is less likely to be inhibited by these interface states; hence, the on-state current of the transistor 801 can be increased.

In addition, as shown in FIG. 14, trap states Et826e and Et827e due to impurities or defects might be formed in the vicinity of the interface between the metal oxide film 821 and the insulating layer 816 and the vicinity of the interface between the metal oxide film 824 and the insulating layer 817, respectively; however, the metal oxide film 822 can be made apart from the trap states Et826e and Et827e owing to the existence of the metal oxide films 821 and 824.

Note that when the difference between Ec821e and Ec822e is small, an electron in the metal oxide film 822 might reach the trap state Et826e by passing over the energy difference. When the electron is trapped at the trap state Et826e, negative fixed charge is generated at the interface with the insulating film, causing the threshold voltage of the transistor to be shifted in the positive direction. The same applies to the case where the energy difference between Ec822e and Ec824e is small.

In order to reduce a change in threshold voltage of the transistor 801 and make the electrical characteristics of the transistor 801 favorable, the difference between Ec821e and Ec822e and the difference between Ec824e and Ec822e are each preferably greater than or equal to 0.1 eV, further preferably greater than or equal to 0.15 eV.

Note that the transistor 801 can alternatively have a structure without a back gate electrode.

### Example of Stacked-Layer Structure

Next, a structure of a semiconductor device including a stack of an OS transistor and another transistor will be described.

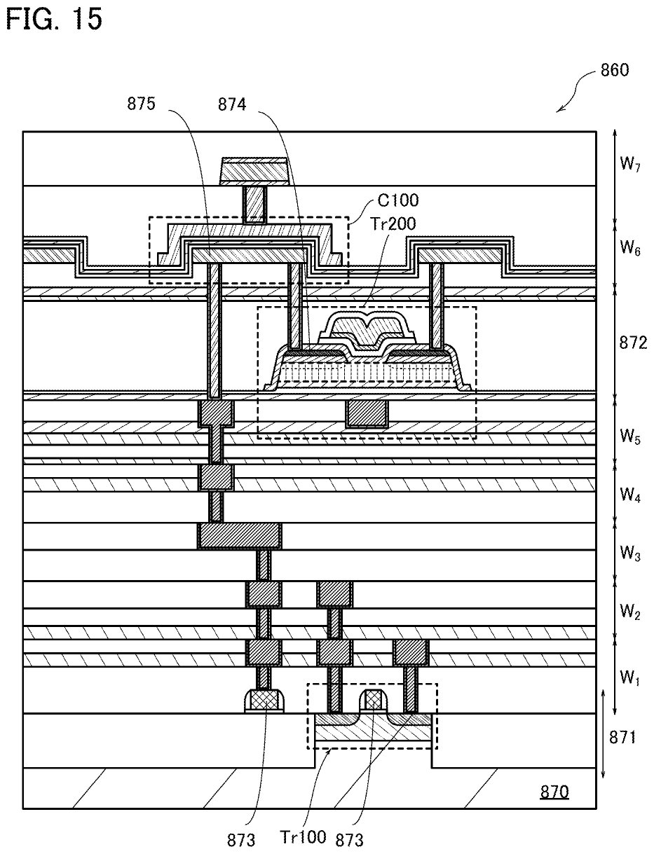

FIG. 15 illustrates an example of a stacked-layer structure of a semiconductor device 860 in which a transistor Tr100 that is a Si transistor, a transistor Tr200 that is an OS transistor, and a capacitor C100 are stacked.

The semiconductor device 860 includes a stack of a CMOS layer 871, wiring layers W₁ to W₅, a transistor layer 872, and wiring layers W₆ and W₇.

The transistor Tr100 is provided in the CMOS layer 871. A channel formation region of the transistor Tr100 is provided in a single crystal silicon wafer 870. A gate electrode 873 of the transistor Tr100 is connected to one electrode 875 of the capacitor C100 through the wiring layers W₁ to W₅.

The transistor Tr200 is provided in the transistor layer 872. In FIG. 15, the transistor Tr200 has a structure similar to that of the transistor 801 (FIG. 13). An electrode 874 corresponding to one of a source and a drain of the transistor Tr200 is connected to the one electrode 875 of the capacitor C100. Note that FIG. 15 illustrates the case where the transistor Tr200 includes its back gate electrode in the wiring layer W₅. The capacitor C100 is formed in the wiring layer W₆.

The OS transistor and other elements are stacked in the above manner, whereby the circuit area can be reduced.

The above-described structure can be used for the semiconductor device 500 described in Embodiment 2 or the like. For example, the transistor Tr100, the transistor Tr200, and the capacitor C100 can be used as the transistor Tr11, the transistor Tr12, and the capacitor C11 in FIG. 10, respectively. It is also possible to use the transistor Tr100, the transistor Tr200, and the capacitor C100 as the transistor Tr21 or Tr24, the transistor Tr22, Tr23, Tr25, or Tr26, and the capacitor C21 or C22 in FIG. 11, respectively.

This embodiment can be combined with the description of the other embodiments as appropriate.

### Embodiment 5

In this embodiment, a metal oxide that can be used for the aforementioned OS transistor will be described. In particular, details about a metal oxide and a CAC (Cloud-Aligned Composite) are described below.

A CAC-OS or a CAC-metal oxide has a conducting function in a part of the material and has an insulating function in a part of the material; as a whole, the CAC-OS or the CAC-metal oxide has a function of a semiconductor. Note that in the case where the CAC-OS or the CAC-metal oxide is used in a channel formation region of a transistor, the conducting function is to allow electrons (or holes) serving as carriers to flow, and the insulating function is to not allow electrons serving as carriers to flow. By the complementary action of the conducting function and the insulating function, a switching function (On/Off function) can be given to the CAC-OS or the CAC-metal oxide. In the CAC-OS or the CAC-metal oxide, separation of the functions can maximize each function.

Furthermore, the CAC-OS or the CAC-metal oxide includes conductive regions and insulating regions. The conductive regions have the above-described conducting function, and the insulating regions have the above-described insulating function. Furthermore, in some cases, the conductive regions and the insulating regions in the material are separated at the nanoparticle level. Furthermore, in some cases, the conductive regions and the insulating regions are unevenly distributed in the material. Furthermore, the conductive regions are observed to be coupled in a cloud-like manner with their boundaries blurred, in some cases.

Furthermore, in the CAC-OS or the CAC-metal oxide, the conductive regions and the insulating regions each have a size greater than or equal to 0.5 nm and less than or equal to 10 nm, preferably greater than or equal to 0.5 nm and less than or equal to 3 nm, and are dispersed in the material, in some cases.

Furthermore, the CAC-OS or the CAC-metal oxide includes components having different bandgaps. For example, the CAC-OS or the CAC-metal oxide includes a component having a wide gap due to the insulating region and a component having a narrow gap due to the conductive region. In the case of the structure, when carriers flow, carriers mainly flow in the component having a narrow gap. Furthermore, the component having a narrow gap complements the component having a wide gap, and carriers also flow in the component having a wide gap in conjunction with the component having a narrow gap. Therefore, in the case where the above-described CAC-OS or CAC-metal oxide is used in a channel formation region of a transistor, high current driving capability in an on state of the transistor, that is, a high on-state current and high field-effect mobility can be obtained.

In other words, the CAC-OS or the CAC-metal oxide can also be referred to as a matrix composite or a metal matrix composite.

A CAC-OS refers to one composition of a material in which elements constituting a metal oxide are unevenly distributed with a size greater than or equal to 0.5 nm and less than or equal to 10 nm, preferably greater than or equal to 1 nm and less than or equal to 2 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 2 nm, or a similar size in a metal oxide is hereinafter referred to as a mosaic pattern or a patch-like pattern.

Note that a metal oxide preferably contains at least indium. In particular, indium and zinc are preferably contained. Moreover, in addition to these, one kind or a plurality of kinds selected from aluminum, gallium, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

For instance, a CAC-OS in an In—Ga—Zn oxide (an In—Ga—Zn oxide in the CAC-OS may be particularly referred to as CAC-IGZO) has a composition in which materials are separated into indium oxide (hereinafter InO_{X1} (X1 is a real number greater than 0)) or indium zinc oxide (hereinafter In_{X2}Zn_{Y2}O_{Z2} (X2, Y2, and Z2 are real numbers greater than 0)) and gallium oxide (hereinafter GaO_{X3} (X3 is a real number greater than 0)) or gallium zinc oxide (hereinafter Ga_{X4}Zn_{Y4}O_{Z4} (X4, Y4, and Z4 are real numbers greater than 0)), for example, so that a mosaic pattern is formed, and mosaic-like InO_{X1} or In_{X2}Zn_{Y2}O_{Z2} is evenly distributed in the film (which is hereinafter also referred to as cloud-like).

That is, the CAC-OS is a composite metal oxide having a composition in which a region including GaO_{X3} as a main component and a region including In_{X2}Zn_{Y2}O_{Z2} or InO_{X1} as a main component are mixed. Note that in this specification, for example, when the atomic ratio of In to an element M in a first region is larger than the atomic ratio of In to the element M in a second region, the first region is regarded as having a higher In concentration than the second region.

Note that IGZO is a commonly known name and sometimes refers to one compound formed of In, Ga, Zn, and O. A typical example is a crystalline compound represented by InGaO₃(ZnO)ₘ₁ (m1 is a natural number) or In(₁₊ₓ₀)Ga(₁₋ₓ₀)O₃(ZnO)ₘ₀ (−1≤x0≤1; m0 is a given number).

The above crystalline compound has a single crystal structure, a polycrystalline structure, or a CAAC (c-axis aligned crystal) structure. Note that the CAAC structure is a crystal structure in which a plurality of IGZO nanocrystals have c-axis alignment and are connected in the a-b plane without alignment.

On the other hand, the CAC-OS relates to the material composition of a metal oxide. The CAC-OS refers to a composition in which, in the material composition containing In, Ga, Zn, and O, some regions that contain Ga as a main component and are observed as nanoparticles and some regions that contain In as a main component and are observed as nanoparticles are randomly dispersed in a mosaic pattern. Therefore, the crystal structure is a secondary element for the CAC-OS.

Note that the CAC-OS is regarded as not including a stacked-layer structure of two or more kinds of films with different compositions. For example, a two-layer structure of a film containing In as a main component and a film containing Ga as a main component is not included.

Note that a clear boundary cannot sometimes be observed between the region where GaO_{X3} is a main component and the region where In_{X2}Zn_{Y2}O_{Z2} or InO_{X1} is a main component.

Note that in the case where one kind or a plurality of kinds selected from aluminum, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like are contained instead of gallium, the CAC-OS refers to a composition in which some regions that contain the metal element(s) as a main component and are observed as nanoparticles and some regions that contain In as a main component and are observed as nanoparticles are randomly dispersed in a mosaic pattern.

The CAC-OS can be formed by a sputtering method under a condition where a substrate is not heated intentionally, for example. Moreover, in the case of forming the CAC-OS by a sputtering method, any one or more selected from an inert gas (typically, argon), an oxygen gas, and a nitrogen gas are used as a deposition gas. Furthermore, the ratio of the flow rate of an oxygen gas to the total flow rate of the deposition gas at the time of deposition is preferably as low as possible, and for example, the ratio of the flow rate of the oxygen gas is preferably higher than or equal to 0% and lower than 30%, further preferably higher than or equal to 0% and lower than or equal to 10%.

The CAC-OS is characterized in that no clear peak is observed in measurement using θ/2θ scan by an Out-of-plane method, which is one of X-ray diffraction (XRD) measurement methods. That is, it is found from the X-ray diffraction that no alignment in the a-b plane direction and the c-axis direction is observed in a measured region.

In addition, in an electron diffraction pattern of the CAC-OS which is obtained by irradiation with an electron beam with a probe diameter of 1 nm (also referred to as a nanobeam electron beam), a ring-like high-luminance region and a plurality of bright spots in the ring region are observed. It is therefore found from the electron diffraction pattern that the crystal structure of the CAC-OS includes an nc (nano-crystal) structure with no alignment in the plan-view direction and the cross-sectional direction.

Moreover, for example, it can be confirmed by EDX mapping obtained using energy dispersive X-ray spectroscopy (EDX) that the CAC-OS in the In—Ga—Zn oxide has a composition in which regions including GaO_{X3} as a main component and regions including In_{X2}Zn_{Y2}O_{Z2} or InO_{X1} as a main component are unevenly distributed and mixed.

The CAC-OS has a composition different from that of an IGZO compound in which the metal elements are evenly distributed, and has characteristics different from those of the IGZO compound. That is, the CAC-OS has a composition in which regions where GaO_{X3} or the like is a main component and regions where In_{X2}Zn_{Y2}O_{Z2} or InO_{X1} is a main component are phase-separated from each other and form a mosaic pattern.

Here, a region where In_{X2}Zn_{Y2}O_{Z2} or InO_{X1} is a main component is a region whose conductivity is higher than that of a region where GaO_{X3} or the like is a main component. In other words, when carriers flow through the regions where In_{X2}Zn_{Y2}O_{Z2} or InO_{X1} is a main component, the conductivity of an oxide semiconductor is exhibited. Accordingly, when the regions containing In_{X2}Zn_{Y2}O_{Z2} or InO_{X1} as a main component are distributed like a cloud in an oxide semiconductor, high field-effect mobility (p) can be achieved.

In contrast, a region where GaO_{X3} or the like is a main component is a region whose insulating property is higher than that of a region where In_{X2}Zn_{Y2}O_{Z2} or InO_{X1} is a main component. In other words, when regions where GaO_{X3} or the like is a main component are distributed in an oxide semiconductor, off-state current can be suppressed and favorable switching operation can be achieved.

Accordingly, when the CAC-OS is used for a semiconductor element, the insulating property derived from GaO_{X3} or the like and the conductivity derived from In_{X2}Zn_{Y2}O_{Z2} or InO_{X1} complement each other, whereby a high on-state current (Iₒₙ) and high field-effect mobility (μ) can be achieved.

Moreover, a semiconductor element using the CAC-OS has high reliability. Thus, the CAC-OS is most suitable for a variety of semiconductor devices.

This embodiment can be combined with the description of the other embodiments as appropriate.

### Embodiment 6

In this embodiment, electronic devices in which the power-receiving device described in the above embodiments can be provided will be described.

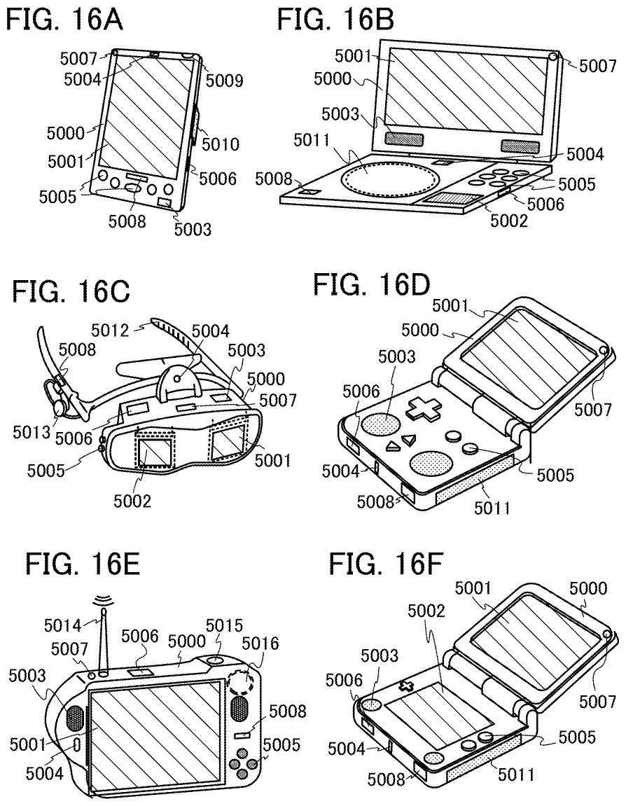

FIG. 16(A) to FIG. 16(F) are drawings illustrating electronic devices. These electronic devices can include a housing 5000, a display portion 5001, a speaker 5003, an LED lamp 5004, operation keys 5005 (including a power switch and an operation switch), a connection terminal 5006, a sensor 5007 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared ray), a microphone 5008, and the like.

FIG. 16(A) illustrates a mobile computer which can include a switch 5009, an infrared port 5010, and the like in addition to the above components. FIG. 16(B) illustrates a portable image reproducing device (e.g., a DVD player) provided with a recording medium, and the portable image reproducing device can include a second display portion 5002, a recording medium reading portion 5011, and the like in addition to the above components. FIG. 16(C) illustrates a goggle-type display which can include the second display portion 5002, a support portion 5012, an earphone 5013, and the like in addition to the above components. FIG. 16(D) illustrates a portable game console which can include the recording medium reading portion 5011 and the like in addition to the above components. FIG. 16(E) illustrates a digital camera with a television reception function, and the digital camera can include an antenna 5014, a shutter button 5015, an image-receiving portion 5016, and the like in addition to the above components. FIG. 16(F) illustrates a portable game console which can include the second display portion 5002, the recording medium reading portion 5011, and the like in addition to the above components.

The electronic devices illustrated in FIG. 16(A) to FIG. 16(F) can have a variety of functions. For example, the electronic devices can have a function of displaying a variety of data (e.g., a still image, a moving image, and a text image) on the display portion, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading out a program or data stored in a recording medium and displaying it on the display portion. Furthermore, the electronic device including a plurality of display portions can have a function of displaying image information mainly on one display portion while displaying text information mainly on another display portion, a function of displaying a three-dimensional image by displaying images where parallax is considered on a plurality of display portions, or the like. Furthermore, the electronic device including an image receiver can have a function of shooting a still image, a function of taking a moving image, a function of automatically or manually correcting a shot image, a function of storing a shot image in a memory medium (an external memory medium or a memory medium incorporated in the camera), a function of displaying a shot image on the display portion, or the like. Note that functions that can be provided for the electronic devices illustrated in FIG. 16(A) to FIG. 16(F) are not limited to those described above, and the electronic devices can have a variety of functions.

The electronic devices described in this embodiment each include a battery and can perform wireless power feeding as described in the above embodiment.

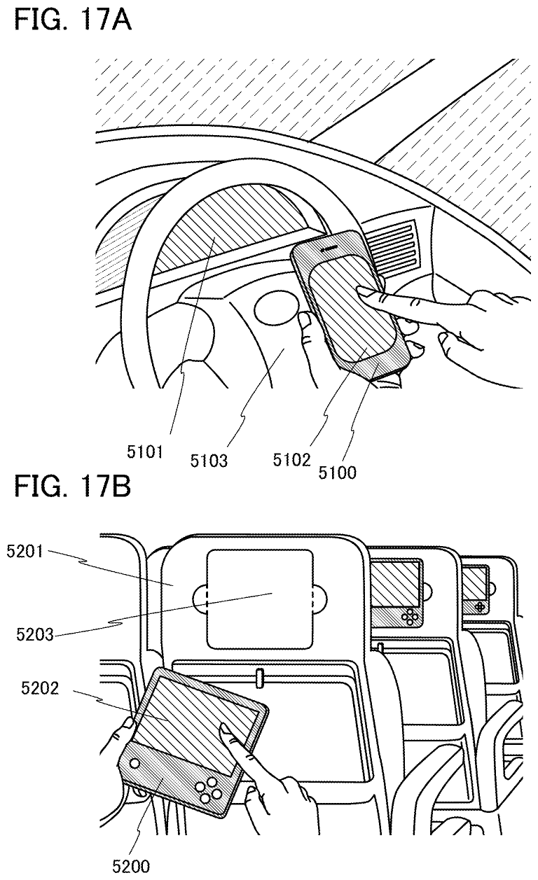

Usage examples of electronic devices are illustrated in FIG. 17(A) and FIG. 17(B).

FIG. 17(A) shows an example where an information terminal is operated in a moving object such as a car.

Reference numeral 5103 indicates a steering wheel, which includes an antenna inside. The antenna in the steering wheel 5103 can supply power to an electronic device 5100. The electronic device 5100 includes a battery that is charged by wireless power feeding. The steering wheel 5103 may be provided with a jig that can fix the electronic device 5100. If the electronic device 5100 is fixed on the steering wheel 5103, the user can make a phone call or a video-phone call without using his/her hands. Furthermore, through voice authentication with the use of a microphone provided in the electronic device 5100, the car can be driven by a voice of the driver.

For example, by operating the electronic device 5100 while the car is parked, the positional information can be displayed on a display portion 5102. Furthermore, information not displayed on a display portion 5101 of the car, such as engine speed, steering wheel angle, temperature, and tire pressure may be displayed on the display portion 5102. The display portion 5102 has a touch input function. Furthermore, one or more cameras to image the outside of the car can be used to display the outside image on the display portion 5102; for example, the display portion 5102 can be used as a back monitor. Furthermore, for preventing drowsy driving, the electronic device 5100 may operate as follows, for example: while wirelessly receiving information such as the driving speed from the car to monitor the driving speed, the electronic device 5100 images the driver at the time of driving and when a period for which the driver closes his/her eyes is long, it vibrates, beeps, or plays music (depending on the setting that can be selected by the driver as appropriate). Furthermore, by stopping imaging the driver while the car is parked, power consumption can be reduced. In addition, the batteries of the electronic device 5100 may be wirelessly charged while the car is parked.

The electronic device 5100 is expected to be used in a variety of ways in a moving object such as a car, as described above, and is desired to incorporate a number of sensors and a plurality of antennas that enable various functions thereof. Although a moving object such as a car has a power supply, the power supply is limited. In view of the power to drive the moving object, it is preferable that the power used for the electronic device 5100 be as low as possible. For an electric vehicle, in particular, power consumed by the electronic device 5100 may decrease the travel distance. Even if the electronic device 5100 has a variety of functions, it is not often that all the functions are used at a time, and only one or two functions are usually used as necessary. In the case where the electronic device 5100 including a plurality of batteries, each of which is prepared for a different function, has a variety of functions, only the function to be used is turned on and power is supplied thereto from a battery corresponding to that function, whereby power consumption can be reduced. Furthermore, batteries corresponding to the functions not in use, among the plurality of batteries, can be wirelessly charged from an antenna provided in the car.

FIG. 17(B) illustrates an example in which an information terminal is operated in an airplane or the like. Since a period in which an individual can use his/her own information terminal is limited in an airplane or the like, the airplane is desired to be equipped with information terminals that the passengers can use when the flight is long.

An electronic device 5200, having a display portion 5202 that displays images such as a movie, a game, and a commercial, is an information terminal with which the current flying location and the remaining flight time can be obtained in real time, owing to its communication function. The display portion 5202 has a touch input function.

The electronic device 5200 can be fit into a depressed portion in a seat 5201, and an antenna installation portion 5203 is provided in a position that overlaps with the electronic device 5200 so that wireless power feeding is achieved while it is fit into the depressed portion. The electronic device 5200 can function as a telephone or communication tool when the user is sick and wants to contact a flight attendant, for example. If the electronic device 5200 has a translation function, the user can communicate with a flight attendant by using the display portion 5202 of the electronic device 5200 even when the user and the flight attendant speak different languages. Furthermore, passengers seated next to one another who speak different languages can communicate by using the display portion 5202 of the electronic device 5200. In addition, the electronic device 5200 can function as a message board, displaying a message in English such as “please do not disturb” on the display portion 5202 while the user is asleep, for example.

The electronic device 5200 may have a plurality of batteries each of which is for a different function, and only the function to be used is turned on while the other functions not in use are in an off state, whereby power consumption can be reduced. Furthermore, among the plurality of batteries, batteries corresponding to the functions not in operation can perform wireless power feeding from the antenna installation portion 5203.

The batteries of the electronic devices 5200 for the plurality of seats may be designed so as to be used in emergency when the airplane has an electrical problem. Since all the electronic devices 5200 for the plurality of seats are the same products having the same design, the system may be constructed such that the electronic devices 5200 can be connected in series as an emergency power supply.

As the plurality of small-sized batteries of the electronic device 5200, one or more kinds selected from the following can be used: a lithium ion secondary battery such as a lithium polymer battery, a lithium ion capacitor, an electric double layer capacitor, and a redox capacitor.

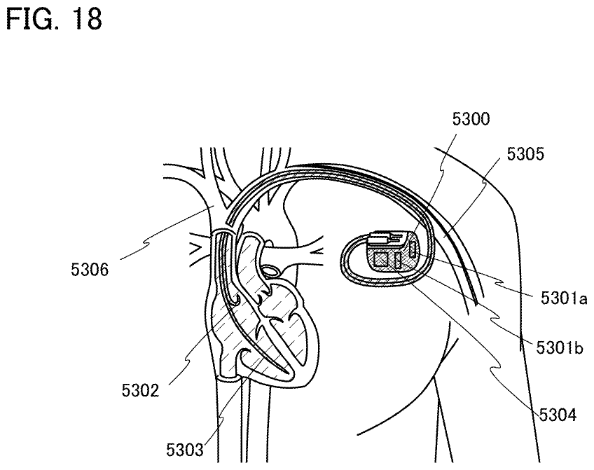

Next, an artificial organ will be described as another example of an electronic device that can be used for the power-receiving portion described in the above embodiment. FIG. 18 is a cross-sectional schematic view of an example of a pacemaker.

A pacemaker body 5300 includes at least batteries 5301a and 5301b, a regulator, a control circuit, an antenna 5304, a wire 5302 reaching a right atrium, and a wire 5303 reaching a right ventricle.

The pacemaker body 5300 is implanted in the body by surgery, and the two wires pass through a subclavian vein 5305 and a superior vena cava 5306 of the human body, with the end of one of the wires placed in the right ventricle and the end of the other wire placed in the right atrium.

The antenna 5304 can receive electric power, and the batteries 5301a and 5301b are charged with the electric power, which can reduce the frequency of replacing the pacemaker. The pacemaker body 5300, which includes the plurality of batteries, provides a high level of safety, and the plurality of batteries also function as auxiliary power supplies because even when one of them fails, the other can function. If the battery to be provided in the pacemaker is further divided into a plurality of thin batteries to be mounted on a printed board where control circuits including a CPU and the like are provided, the pacemaker body 5300 can be smaller in size and thickness.

Other than the antenna 5304 capable of receiving electric power, an antenna that can transmit physiological signals may be included; for example, a system that monitors the cardiac activity so as to check physiological signals such as a pulse, a respiratory rate, a heart rate, and body temperature with an external monitoring device may be constructed.

Note that how the pacemaker is placed here is just an example, and it can be changed in various ways depending on the heart disease.

This embodiment is not limited to the pacemaker. An artificial ear is an artificial organ that is more widely used than the pacemaker. An artificial ear converts a sound into an electric signal and directly stimulates the auditory nerve with a stimulus device in the cochlea.

An artificial ear includes a first device implanted deep in the ear by surgery and a second device that picks up sounds with a microphone and sends them to the implanted first device. The first device and the second device are not electrically connected to each other, and transmitting and receiving between the two are conducted wirelessly. The first device includes at least an antenna that receives an electric signal converted from a sound and a wire that reaches the cochlea. The second device includes at least a sound processing portion for converting a sound into an electric signal and a transmitting circuit that transmits the electric signal to the first device.

This embodiment can be combined with the description of the other embodiments as appropriate.

### REFERENCE NUMERALS

100: power-feeding device, 101: arrow, 110: power-feeding coil, 120: control device, 121: position control signal, 122: position control circuit, 123: output control signal, 124: output control circuit, 130: sensing device, 130a: sensing device, 130b: sensing device, 131: sensing coil, 131a: sensing coil, 131b: sensing coil, 132: sensing coil, 132a: sensing coil, 132b: sensing coil, 133a: region, 133b: region, 133c: region, 135: substrate, 136: sensing device, 137: arrow, 138: dielectric, 140: moving device, 141: rail, 142: rail, 143: coil base, 144: tire, 150: housing, 200: power-receiving device, 210: power-receiving coil, 220: power storage device, 300: electronic device, 500: semiconductor device, 510: memory circuit, 520: reference memory circuit, 530: circuit, 540: circuit, 550: current supply circuit, 801: transistor, 811: insulating layer, 812: insulating layer, 813: insulating layer, 814: insulating layer, 815: insulating layer, 816: insulating layer, 817: insulating layer, 818: insulating layer, 819: insulating layer, 820: insulating layer, 821: metal oxide film, 822: metal oxide film, 822n: region, 823: metal oxide film, 824: metal oxide film, 830: oxide layer, 850: conductive layer, 850a: conductive layer, 850b: conductive layer, 851: conductive layer, 852: conductive layer, 853: conductive layer, 853a: conductive layer, 853b: conductive layer, 860: semiconductor device, 870: single crystal silicon wafer, 871: CMOS layer, 872: transistor layer, 873: gate electrode, 874: electrode, 875: electrode, 5000: housing, 5001: display portion, 5002: display portion, 5003: speaker, 5004: LED lamp, 5005: operation key, 5006: connection terminal, 5007: sensor, 5008: microphone, 5009: switch, 5010: infrared port, 5011: recording medium reading portion, 5012: support portion, 5013: earphone, 5014: antenna, 5015: shutter button, 5016: image-receiving portion, 5100: electronic device, 5101: display portion, 5102: display portion, 5103: steering wheel, 5200: electronic device, 5201: seat, 5202: display portion, 5203: antenna installation portion, 5300: pacemaker body, 5301a: battery, 5301b: battery, 5302: wire, 5303: wire, 5304: antenna, 5305: subclavian vein, 5306: superior vena cava

1. A power-feeding device comprising:
a power-feeding coil;
a control device;
a sensing device; and
a moving device,
wherein the power-feeding coil is configured to generate a magnetic field,
wherein the control device is electrically connected to the power-feeding coil and the sensing device,
wherein the control device is configured to determine a position of the power-feeding coil and to transmit a position control signal,
wherein the moving device is configured to receive the position control signal and to move the power-feeding coil based on the position control signal,
wherein the sensing device includes a first sensing coil and a second sensing coil,
wherein the first sensing coil is configured to generate a magnetic field, and
wherein the second sensing coil is configured to sense a change in magnetic flux density.

2. A power-feeding device comprising:
a power-feeding coil;
a control device;
a sensing device; and
a moving device,
wherein the power-feeding coil is configured to generate a magnetic field,
wherein the control device is electrically connected to the power-feeding coil and the sensing device,
wherein the control device is configured to determine a position of the power-feeding coil and to transmit a position control signal,
wherein the moving device is configured to receive the position control signal and to move the power-feeding coil based on the position control signal,
wherein the sensing device includes a first coil group and a second coil group, and
wherein the second coil group is positioned in a region surrounded by any one of coils included in the first coil group.

3. The power-feeding device according to claim 2,
wherein at least one of the first coil group and the second coil group includes a first sensing coil and a second sensing coil,
wherein the first sensing coil is configured to generate a magnetic field, and
wherein the second sensing coil is configured to sense a change in magnetic flux density.

4. The power-feeding device according to claim 1,
wherein the control device includes a neural network,
wherein sensing data is input to an input layer of the neural network, and
wherein the position control signal is output from an output layer of the neural network.

5. A wireless power-feeding system comprising:
the power-feeding device according to claim 1; and
a power-receiving device,
wherein the power-receiving device includes a power storage device and a power-receiving coil,
wherein the power storage device is electrically connected to the power-receiving coil and able to be charged with power induced by the power-receiving coil, and
wherein the control device is configured to determine the position of the power-feeding coil based on a position of the power-receiving coil.

6. The power-feeding device according to claim 2,
wherein the control device includes a neural network,
wherein sensing data is input to an input layer of the neural network, and
wherein the position control signal is output from an output layer of the neural network.

7. A wireless power-feeding system comprising:
the power-feeding device according to claim 2; and
a power-receiving device,
wherein the power-receiving device includes a power storage device and a power-receiving coil,
wherein the power storage device is electrically connected to the power-receiving coil and able to be charged with power induced by the power-receiving coil, and
wherein the control device is configured to determine the position of the power-feeding coil based on a position of the power-receiving coil.
